(19) United States
(12) Patent Application Publication
(10) Pub. No.: US 2011/0040668 A1
(43) Pub. Date: Feb. 17, 2011

(54) AUTOMATED SPREAD TRADING SYSTEM

(75) Inventors: Darren Lee, London (GB); Richard Banks, London (GB); David Anderson, Cowdenbeath (GB)

Correspondence Address: BAINWOOD HUANG & ASSOCIATES LLC, 2 CONNECTOR ROAD, WESTBOROUGH, MA, 01581, US

(73) Assignee: Darren Lee, London (GB)

(21) Appl. No.: 12/857,946

(22) Filed: Aug. 17, 2010

Related U.S. Application Data
(60) Provisional application No. 61/234,488, filed on Aug. 17, 2009.

(51) Int. Cl. G06Q 40/00

(52) U.S. Cl. 705/37

(57) ABSTRACT

An automated spread trading terminal receives from a user a selection of a spread trade indicative of a set of trading contracts and transmits to an electronic trading exchange a first set of messages including an order message relating to the user selection such that an initial set of more working orders are rendered operative. The terminal receives from the electronic trading exchange a first fill confirmation message confirming at least partial completion of a first working order, and in response transmits to the electronic trading exchanges both second and third sets of messages such that a completing set of working orders are rendered operative and additional working orders corresponding to the trading contracts are rendered operative, the third set of messages being transmitted before the set of working orders is completed.

### BACKGROUND

The present invention relates to an automated spread trading system designed to allow a user to automatically perform spread trades in one or more electronic trading exchange systems.

Systems for electronically trading contracts exist where a plurality of terminals connect to an electronic trading exchange system (or several electronic trading exchange systems) in order to receive data relating to contracts and transmit and receive data relating to orders for these contracts. Users controlling the terminals are presented with a graphical user interface through which the market (i.e. other orders and trades) for a contract or contracts can be viewed, and desired contracts can be selected in order to request orders to buy or sell these contracts. The terminals communicate with an electronic trading exchange system in order to execute the orders requested, and display the results of the execution of the orders.

Users may execute a spread trade consisting of a number of orders for a number of different contracts on these terminals to be executed simultaneously by using the graphical user interface to request an order for each contract of which the spread trade is to be comprised. However a user will find it difficult to keep track of both market changes relating to the orders he wishes to place and changes relating to the orders themselves.

United States patent application publication number US 2003/2020167 A1 describes a terminal for automatic spread trading. A spread data feed is generated in response to market data feeds and using spread parameters entered by a user. The spread data feed is displayed via a graphical user interface to the user, who can request that spread trades be performed via this interface. Orders will then be automatically executed at an electronic trading exchange system and managed in order to achieve, or attempt to achieve, the spread price required by the user, or better.

United States patent application publication number US 2006/0271468 A1 describes a system for electronically inputting, monitoring and trading spread trades. A terminal provides a dynamic display of electronic trading information for trading spreads and allows the user to input spreads composed of multiple orders via a user interface. One or more orders relating to an entered spread trade can then be automatically executed by the terminal on one or more electronic trading exchange systems.

The prior art thus allows users to select and enter a spread trade, orders for which are then executed automatically. Changes in trading markets can happen very quickly however and it may be the case that once a spread trade has been executed using one of the terminals described in the prior art the markets for the contracts involved in the spread trade fluctuate rapidly. Using the terminals described in the prior art a user may be unable to react quickly enough to many of the rapid changes that occur in trading markets, hence many trading opportunities may be missed.

The present invention improves upon the prior art by providing an automated spread trading system designed to allow a user to automatically perform spread trades at an electronic trading exchange system, and particularly to rapidly execute orders and/or spread trades in response to the completion of previous orders and/or spread trades so as to provide a processing advantage over the prior art and to allow a user to take advantage of volatility in trading markets.

### SUMMARY

In accordance with one aspect of the present invention, there is provided a computer-implemented method for generating and transmitting, via a data communications network, messages related to a spread trade, said method comprising:

in a computer process, receiving from a user a selection of a spread trade indicative of a set of trading contracts defined in relation to the spread trade;

in a computer process, transmitting to at least one electronic trading exchange a first set of one or more messages, including one or more order messages relating to said user selection such that an initial set of one or more working orders, each corresponding to one of the trading contracts defined in relation to the selected spread trade are rendered operative in the at least one electronic trading exchange;

in a computer process, receiving from the at least one electronic trading exchange a first fill confirmation message confirming the at least partial completion of a first working order in said initial set of working orders; and

in a computer process, in response to receiving said first fill confirmation message, transmitting to at least one of the at least one electronic trading exchanges both:
a) a second set of one or more messages, including one or more order messages and/or order modification messages, relating to said user selection such that a completing set of one or more working orders, each corresponding to one or more of the trading contracts defined in relation to the selected spread trade, are rendered operative in the at least one of the at least one electronic trading exchanges, the completing set of working orders relating to one or more trading contracts including one or more trading contracts other than the trading contract in relation to which said first fill confirmation message has been received and the completing set of working orders being completed subsequent to said second set of messages being sent, when one or more further fill confirmation messages are received; and
b) a third set of one or more messages, including one or more order messages relating to said user selection such that an additional set of one or more working orders, each corresponding to one or more of the trading contracts defined in relation to the selected spread trade, are rendered operative in the at least one of the at least one electronic trading exchanges, the additional set of working orders relating to one or more trading contracts including the trading contract in relation to which said first fill confirmation message has been received,

wherein said third set of messages are transmitted before said completing set of working orders is completed.

By rendering operative an additional set of one or more working orders, each corresponding to one or more of the trading contracts defined in relation to the selected spread trade, are transmitted before the completing set of working orders is completed, trading in the selected spread trade can be automatically triggered multiple times, whilst the completing set of working orders are being completed, in response to an at least partial fill of one leg the spread trade.

In accordance with a further aspect of the present invention, there is provided a computer implemented method for transmitting to an electronic trading exchange, via a data communications network, one or more messages relating to a set of orders related to a spread trade, said spread trade relating to a selection of spread trade contracts, to render operative one or more working orders relating to one or more contracts in said selection of spread trade contracts, said method comprising:

in a computer process, receiving fill confirmation data from the electronic trading exchange confirming the at least partial completion of a first working order, said first working order relating to a first spread trade;

in a computer process, in response to receiving said fill confirmation data from the electronic trading exchange, transmitting to the electronic trading exchange one or more messages relating to a set of one or more completing orders relating to the first spread trade such that there is an order in said set of completing orders for one or more contracts in said selection of spread trade contracts other than a contract to which the first working order relates; and

transmitting to the electronic trading exchange one or more messages relating to an opposing additional order, wherein said opposing additional order relates to the same contract as the first order.

By implementing a method in accordance with this aspect of the invention, a working leg of a spread trade, which has been at least partially filled, can be matched with an opposing additional order, and a set of one or more completing orders relating to the spread trade can be triggered, in response to the filling of the working leg of the spread trade.

In accordance with a yet further aspect of the present invention, there is provided a computer-implemented method for transmitting to an electronic trading exchange, via a data communications network, one or more messages relating to a set of order messages related to a spread trade, said spread trade relating to a selection of spread trade contracts, to render operative one or more working orders relating to one or more contracts in said selection of spread trade contracts, said method comprising:

in a computer process, receiving fill confirmation data from the electronic trading exchange confirming the at least partial completion of a first working order, said first working order relating to a first spread trade;

in a computer process, in response to receiving said fill confirmation data from the electronic trading exchange, transmitting to the electronic trading exchange one or more messages relating to a set of one or more completing orders relating to the first spread trade such that there is an order in said set of completing orders for one or more contracts in said selection of spread trade contracts other than a contract to which the first working order relates; and

in a computer process, transmitting to the electronic trading exchange one or more messages relating to a set of one or more opposing additional orders relating to a spread trade such that for every working order in said first set of one or more working orders there is an opposing working order relating to the same contract as the working order in said set of opposing additional working orders.

By implementing a method in accordance with this aspect of the invention, a spread trade, which has been at least partially filled, can be matched with an opposing spread trade, and a set of one or more completing orders can be triggered, in response to the filling of the working leg of the spread trade.

In accordance with a yet further aspect of the present invention, there is provided a computer-implemented method for transmitting to an electronic trading exchange, via a data communications network, one or more messages relating to a set of order messages related to a spread trade, said spread trade relating to a selection of spread trade contracts, to render operative one or more working orders relating to one or more contracts in said selection of spread trade contracts, said method comprising:

in a computer process, receiving fill confirmation data from the electronic trading exchange confirming the at least partial completion of a first working order, said first working order relating to a first spread trade,

in a computer process, in response to receiving said fill confirmation data from the electronic trading exchange, transmitting to the electronic trading exchange one or more messages relating to a set of one or more completing orders relating to the first spread trade for one or more contracts in said selection of spread trade contracts other than a contract to which the first working order relates,

in a computer process, transmitting to the electronic trading exchange one or more messages relating to a first set of one or more additional orders relating to a spread trade adding to the position such that for one or more working orders in said first set of one or more additional orders there is an adding working order relating to the same contract as the completed first working order; and
in a computer process, transmitting to the electronic trading exchange one or more messages relating to a second set of one or more additional orders relating to an opposing spread trade such that for one or more working orders in said second set of one or more additional orders there is an opposing working order relating to the same contract as the completed first working order.

By implementing a method in accordance with this aspect of the invention, a spread trade, which has been at least partially filled, can be matched with both an opposing spread trade and a reload of the same spread trade, and a set of one or more completing orders can be triggered, in response to the filling of the working leg of the spread trade.

Further aspects of the invention provide a computer-readable medium comprising code capable of causing a computer system to conduct a computer-implemented method for generating and transmitting, via a data communications network, messages related to a spread trade, in accordance with the above aspects of the invention.

Further features and advantages of the invention will become apparent from the following description of preferred embodiments of the invention, given by way of example only, which is made with reference to the accompanying drawings.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1a schematically illustrates the principle components and communication links of a system for performing automated spread trading according to different embodiments of the present invention.

FIG. 1b illustrates the steps performed to set up a spread trade and then instruct the AST terminal 100 to transmit orders relating to the spread trade to the electronic trading exchange 122 using a graphical user interface.

FIG. 2 illustrates the steps performed by the spreader component 108 in order to execute an initial set of working orders for a new spread trade after a new spread trade has been activated.

FIG. 3a illustrates the steps performed by the hedger component 110 in order to fill a hedge order for a leg of a spread trade where that hedge order belongs to the completing set of orders of the spread trade, after one of the working orders in the initial set of working orders of the spread trade has been filled at a price consistent with the spread order price (or better), recent trade data and current market data known to the spreader 108.

FIG. 3b illustrates an alternative set of steps performed by the hedger component 110 in order to create or convert an order or shared order for a new hedge order in step 308 of FIG. 3a when the ‘Queue Saving’ feature of the AST terminal 100 is enabled.

FIG. 3c shows the steps that may be performed by either the spreader 108, or the hedger 110, if either of these components requests to modify the price of a shared order in step 206 or step 310, respectively.

FIG. 4 illustrates additional steps performed by the spreader 108 in order to execute a spread trade with ‘Tick No Hedge’ settings enabled for at least one of the working legs of the spread trade.

FIG. 5 illustrates additional steps performed by the spreader component 108 in response to a complete fill on one of the working legs in the initial set of working orders of an ‘Auto Take Profit’ spread trade.

FIG. 6 illustrates additional steps performed by the spreader component 108 in response to a complete fill on one of the working orders in the initial set of working orders of an ‘Auto Reload’ spread trade.

FIG. 7 shows an exemplary screenshot of the user interface of the system that allows the user to select the contracts of which a new spread template will be comprised.

FIG. 8 shows an exemplary screenshot of the user interface of the system that allows the user to select a spread template and set several parameters relating to the spread template.

FIG. 9 shows an exemplary screenshot of the user interface of the system that allows the user to select a leg of a spread template and set several parameters relating to the leg of the spread template.

FIG. 10 shows an exemplary screenshot of how the user creates a new ticket from a selected spread template 1000 by opening a ‘menu’ listing new ticket types 1002.

FIGS. 11a, 11b and 11c show exemplary screenshots of a ticket window for a standard spread trade.

FIGS. 12a, 12b and 12c show exemplary screenshots of an ‘Auto Take Profit’ ticket window.

FIGS. 13a, 13b, 13c and 13d show exemplary screenshots of an ‘Auto Reload’ ticket window.

FIG. 14 shows an exemplary screenshot of a spread order list window.

FIG. 15 shows an exemplary screenshot of a list of hedge orders.

### DETAILED DESCRIPTION

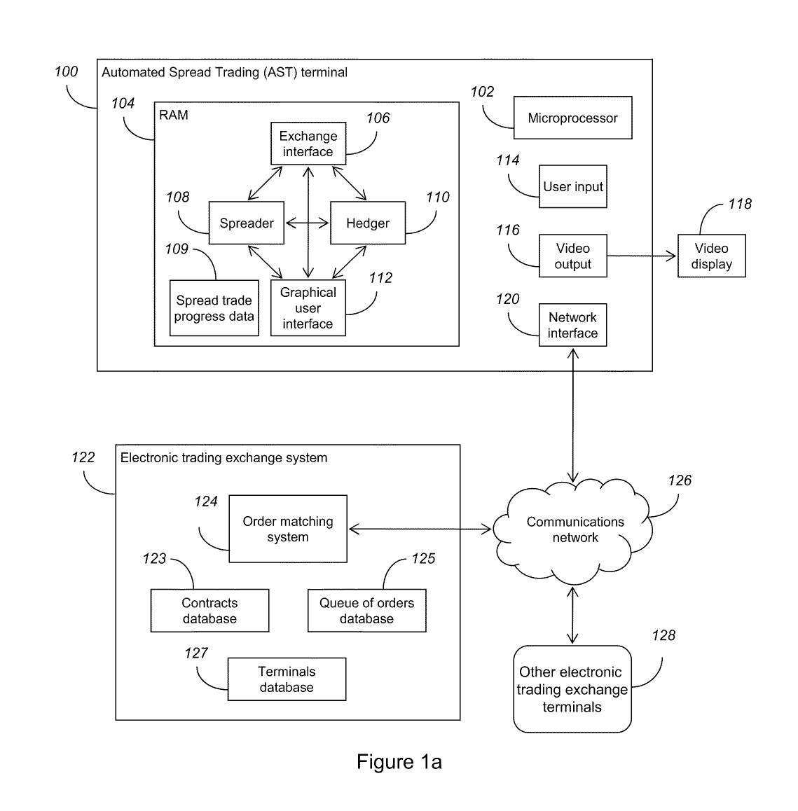

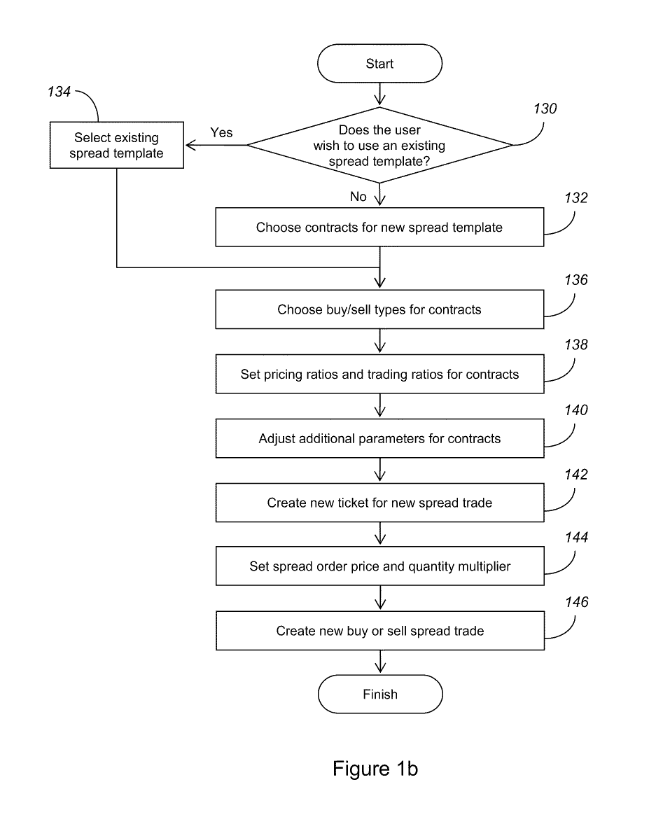

FIG. 1a schematically illustrates the principle components and communication links of a system for performing automated spread trading according to different embodiments of the present invention.

An Automated Spread Trading (AST) terminal 100 may be a general purpose computer such as a desktop personal computer, or other type of computing device such as a bespoke trading terminal, a smartphone, etc. The AST terminal 100 in this embodiment includes a microprocessor 102 that processes instructions in the form of electronic signals stored in a random access memory (RAM) 104 that have been loaded from a computer-readable medium such as a hard disk (not illustrated). These instructions are in the form of computer software, in the form of one or more programs that implement an exchange interface 106, a spreader component 108, a hedger component 110, and a graphical user interface component 112. The RAM 104 is also used by programs running on the microprocessor 102 as a means of storing and accessing data in the form of electronic signals where said data is used during the execution of said programs, such as for example the electronic signals relating to spread trade progress data 109 relating to spread trades performed by the spreader 108 and hedger 110. The terminal 100 also includes a video output device 116 that is able to render graphics produced by programs running on the microprocessor 102 and output these to a video display device 118, or a plurality of such video display devices 118. Programs running on the microprocessor 102 can process user input received via user input interface 114 for accepting user input from a user input device or devices (not shown) such as a mouse and/or computer keyboard. The AST terminal 100 also includes a network interface 120 such as a network card or a broadband modem that allows programs running on the microprocessor 102 to transmit and receive data over a data communications link via a communications network 126 such as the Internet, a private data communications network or a leased line in a public data communications network, to and from an electronic trading exchange system 122.

The electronic trading exchange system 122, which is an exemplary one of a plurality of different exchanges with which the AST terminal 100 is arranged to communicate with in order to conduct trades, includes a plurality of computing devices, for example server computers, which run order matching and other service applications, interconnected in order to provide a reliable distributed set of computing devices which cooperate to form the electronic trading exchange system 122.

The graphical user interface component 112 of the AST terminal 100 provides a graphical user interface (GUI) displayed via the video output component 116 on the video display 118 that allows a user to enter and control spread trades relating to a plurality of contracts with a user input device (or devices). The spreader component 108 and hedger component 110 perform so as to automatically submit and manage orders for contracts relating to user entered spread trades via an exchange interface 106. Information relating to the orders and spread trades managed by the spreader component 108 and hedger component 110 is stored in spread trade progress data 109 held in RAM 104, and may be either shared between the spreader component 108 and hedger component 110 or transferred between them when appropriate. The exchange interface 106 communicates via a communications network 126 with the electronic trading exchange system 122 or a plurality of such electronic trading exchange systems (not shown) in order to create orders, receive updates regarding orders, and modify orders for contracts submitted and managed by the spreader component 108 and hedger component 110, and also receives trading data from the electronic trading exchange system 122 (or systems) in relation to contracts that have been traded so that this information can be used by the spreader component 108 and/or hedger component 110 and/or can be displayed on the graphical user interface component 112.

The electronic trading exchange system 122 comprises an order matching system 124 for matching orders for contracts received from the AST terminal 100 and a plurality of other electronic trading exchange terminals 128. The electronic trading exchange system 122 may also comprise a queue of orders database 125 used to store information relating to received orders that have not yet been matched, a contracts database 123 used to store information relating to the contracts that may be traded at the electronic trading exchange system 122, and a terminals database 127 used to store information relating to the trading terminals connected to the electronic trading exchange system such as the AST terminal 100 and the plurality of other electronic trading exchange terminals 128.

The plurality of other electronic trading exchange terminals 128 may include electronic trading exchange terminals which are programmed to operate according to the automated spread trade methods used by the AST terminal 100 in accordance with the present invention, and may include other electronic trading exchange terminals which need not operate according to the methods used by the AST terminal 100. Such other electronic trading exchange terminals may for example include terminals which operate according to an automated trading system provided by Trading Technologies, and may include manual order entry terminals that may be used to place individual orders that may or may not relate to spread trades. The electronic trading exchange system 122 provides data communications interfaces through which a plurality of users can trade contracts electronically by means of data communications, allowing many contracts to be traded by a large number of users. A contract could typically be a futures contract which is a contract to buy or sell a quantity of a particular commodity at a certain point in the future. A spread trade will typically relate to a combination of two or more of such contracts. A spread trade may for example involve buying a contract for crude oil and selling a contract for a petroleum product derived from crude oil such as gasoline.

In order to perform a trade on a particular contract, an electronic trading exchange terminal (e.g. one of AST terminal 100 or electronic trading exchange terminals 128) may transmit a request in the form of a data message relating to an order to the electronic trading exchange system 122 where that contract is traded. Each order data message may include a contract identifier that uniquely identifies the contract that is to be traded, a buy/sell type indicating whether the contract is to be bought (i.e. the order is a bid) or sold (i.e. the order is an offer), a price value indicating the price at which the contract is to be bought or sold, and a quantity value indicating the quantity to purchase or sell. The price of an order is identified in the data message according to a format determined by the electronic trading exchange system 122 and known to the exchange interface 106. In general the smallest possible change in any price is measured in terms of a standardised unit called a ‘tick’. The quantity of an order is also identified in the data message in terms of a standardised unit. In order to allow the electronic trading exchange system 122 to determine the terminal that has transmitted an order, the order message may also contain a unique terminal identifier. Each order message received by the electronic trading exchange system 122 is assigned a unique order identifier by the electronic trading exchange system 122. Upon receipt of a new order message the electronic trading exchange system 122 transmits a new order confirmation data message containing the unique identifier of the new order to the terminal that sent the order, as this is used by both the terminal and electronic trading exchange to identify the order in future communications.

The electronic trading exchange system 122 receives orders from a number of electronic trading exchange terminals 100, 128, and these are processed by an order matching system 124. The order matching system 124 stores orders received from terminals in a queue of orders database 125. The order matching system 124 attempts to match pairs of orders held in the queue of orders database 125 where one order in each pair is a bid to buy a particular contract and the other is an offer to sell the same contract at the same price.

A pair of orders that relate to the same contract, with one an order to buy the contract at a given price and the other an order to sell the contract at the same price will be matched by the matching system 124. An order that cannot yet be matched with any other order remains in the queue of orders 125. Orders can be partially matched if the quantities of two otherwise matching orders differ, i.e. the order for the smaller quantity will be completely matched, whilst the order for the larger quantity will be partially matched, with the order for the larger quantity modified at the electronic trading exchange system 122 so that the un-matched quantity remains at the same position in the queue of orders.

The matching system 124 may match orders on a first in first out (FIFO) basis, such that orders that were received earlier (and are hence closer to the front of the queue of orders) may be given priority over orders that were received later.

Alternatively when matching orders the matching system 124 may not give priority to orders that were received earlier, but instead may match orders on a pro rata basis. For example if two orders O₁ and O₂ to buy a contract at a price of 10 are in the queue of orders at the order matching system 124, where the quantities of orders O₁ and O₂ are 30 and 70, respectively, then if an order O₃ to sell the same contract at a price of 10 and a quantity of 10 arrives at the electronic trading exchange system 122 the order matching system 124 will partially match orders O₁ and O₂ according to their respective proportion of the total quantity (i.e. 100) bid for the contract at the price of 10, and the quantity of O₃. In this example the matched quantities of O₁ and O₂ will be 3 and 7, respectively.

Electronic trading exchange terminals 100, 128 may request that the price and/or quantity of an order that has not yet been matched (i.e. that is still in the queue of orders 125 at the electronic trading exchange system 122) be modified by transmitting to the electronic trading exchange system 122 an order modification data message. The order modification message transmitted to the electronic trading exchange system 122 comprises the unique identifier of the order to be modified, the price value to use for the modified order, and the quantity value to use for the modified order. If the electronic trading exchange system 122 receives an order modification message before the specified order is matched it will modify the specified order and transmit an order modification confirmation data message to the terminal that transmitted the order modification message. Some electronic exchanges will move the specified order to the back of the queue of orders if the order is modified, depending on the modification made, for example if the quantity of the order is increased or if the price of the order is changed the order may be moved to the back of the queue of orders.

Electronic trading exchange terminals 100, 128 may also request that an order that has not yet been matched be cancelled by transmitting to the electronic trading exchange system 122 an order cancellation data message containing the unique identifier of the order to be cancelled. If the electronic trading exchange system 122 receives an order cancellation message before the specified order is matched, the order will be cancelled and removed from the queue of orders, and the electronic trading exchange will transmit an order cancellation confirmation data message to the terminal that transmitted the order cancellation message.

Once a pair of orders has been matched, the orders will be removed from the queue of orders (or for partially matched orders the quantity of the larger order will be reduced by the matched quantity and the order will remain in the same queue position) and for each order a fill confirmation data message will be sent to the terminal that sent the order informing it that the order has been ‘filled’ (i.e. a match has occurred for the order). This fill confirmation message contains the identifier of the order, the quantity of the order that was matched and the price it was matched at. Some electronic trading exchange systems 122 will also broadcast a trading update data message indicating that a trade (i.e. a matched pair of orders) for a contract has occurred to a plurality of terminals connected to the exchange, these being all relevant terminals, which may be all active terminals or a subset of the active terminals which are interested in the trading update data for that particular contract. The data broadcast includes the identifier of the contract that was traded, the price it was traded at, and the quantity traded.

Some electronic trading exchange systems 122 will transmit to electronic trading exchange terminals 100, 128 recent trade data messages relating to the most recently completed trade or trades for a particular contract. For example, the electronic trading exchange system 122 may transmit recent trade messages including data providing the price (or prices) and quantity (or quantities) of the most recently completed trade (or trades) for a particular contract to a terminal 100, 128 in such a response. Additionally some electronic trading exchange systems 122 will transmit to electronic trading exchange terminals 100, 128 current market data messages relating to the queue of bids and offers for a particular contract that have not yet been matched. For example, the electronic trading exchange system 122 may transmit current market messages including data providing the highest current bid price (i.e. the highest price of the bid orders for the contract in the queue of orders) or the lowest current offer price (i.e. the lowest price of the offer orders for the contract in the queue of orders). Some electronic trading exchange systems 122 will include in the current market messages data relating to all of the bids and offers relating to a particular contract in the queue of orders, whilst others may only include the highest bid and lowest offer in the current market messages, or the highest n bids and the lowest n offers. Both recent trade messages and current market messages relating to a particular contract may be transmitted to a terminal 100, 128 by an electronic trading exchange system 122 in response to a request made by the terminal for the recent trade data or current market data, respectively, or this data may be transmitted at regular intervals to all relevant terminals, which may be all active terminals or a subset of the active terminals which are interested in the recent trade data or current market data for that particular contract or it may be transmitted to all relevant terminals in response to a trade completing for that contract or a change in the queue of orders for that contract.

The AST terminal 100 comprises an exchange interface 106 that provides a set of standardised methods for creating, modifying and cancelling orders at a number of electronic exchanges (e.g. 122) and requesting and receiving recent trade data and current market data from those electronic exchanges by transmitting and receiving data to/from them via the communications network 126 as summarised above. The exchange interface 106 is accessible to the spreader component 108 and hedger component 110 in order to execute orders relating to spread trades as required by the user of the AST terminal 100 at either a single electronic trading exchange system 122, or at multiple electronic exchanges. The AST terminal 100 may comprise a plurality of different exchange interfaces, each adapted for different electronic trading exchange systems. Each of these exchange interfaces may be used by the spreader component 108 and hedger component 110.

The AST terminal 100 as described above is designed in such a way as to allow a user to set up the terminal to automatically perform spread trades at an electronic trading exchange system 122 (or at a number of such electronic exchanges), and particularly to rapidly execute orders and/or spread trades in response to the completion of previous orders and/or spread trades so as to take advantage of the volatility of trading markets.

A spread trade comprises at least one order to buy or sell a contract and at least one other order to buy or sell a contract where each buy/sell order is for a different contract and where the trader performing the spread trade believes that the prices of the contracts involved in the spread trade may be somehow related. Each contract that is bought or sold as part of a spread trade is known as one of the ‘legs’ of the spread trade. A trader will typically perform a spread trade when the difference between the prices of the contracts involved in the spread trade is at a pre-determined level in the hope that the difference between the prices of the same contracts will later change favourably, at which point the trader can make a profit by buying back (and selling out, as appropriate) quantities of the same contracts involved in the spread trade. A trader may also perform individual buy or sell trades which are not part of a spread trade.

For example, a trader may choose to perform a spread trade by selling a contract for crude oil at its current price of $1 per barrel and buying a contract for gasoline at its current price of $2 per barrel, as he feels that the price of the gasoline contract is currently cheap in relation to the price of the crude oil contract. If at a later stage the difference between the prices of the gasoline and crude oil contracts increases, for example if the price of the gasoline contract rises to $2.10, whilst the price of crude oil remains at its price of $1 per barrel, the trader can make a profit by buying back the crude oil contract at $1 and selling the gasoline contract at $2.10.

In order to allow a user to set up a terminal to automatically perform spread trades at an electronic trading exchange system 122 and take advantage of fluctuations in the prices of contracts, the AST terminal 100 contains a spreader component 108 and hedger component 110 that use the exchange interface 106, or a plurality of such interfaces for different exchanges, to manage spread trades entered by the user using means for accepting user input 114 to control the graphical user interface component 112. Information relating to the orders and spread trades managed by the spreader component 108 and hedger component 110 is stored in spread trade progress data 109 held in RAM 104, and may be either shared between the spreader component 108 and hedger component 110 or transferred between them when appropriate.

As is explained in greater detail below and in FIGS. 1b, 2 and 3, the user enters parameters for a new spread trade comprised of a number of ‘legs’, some of which are marked as ‘working’ legs, where each leg has a corresponding contract which is bought or sold at the electronic trading exchange system 122 in order to execute the spread trade. When the spread trade is activated by the user, the spreader component 108 creates orders at the electronic trading exchange system 122 for the working legs in order to buy or sell the contracts associated with those legs and manages these so that they will be filled at a price consistent with a desired spread price. These orders created by the spreader 108 form an initial set of working orders for the spread trade. Once an order for a working leg is filled, the hedger component 110 may execute orders at the electronic trading exchange system 122 for all the legs of the spread trade except the working leg whose order has been filled, in order to buy or sell the contracts associated with those legs at a price consistent with a desired spread price or better, and in order to complete the spread. These orders worked by the hedger 110 form a completing set of orders for the spread trade.

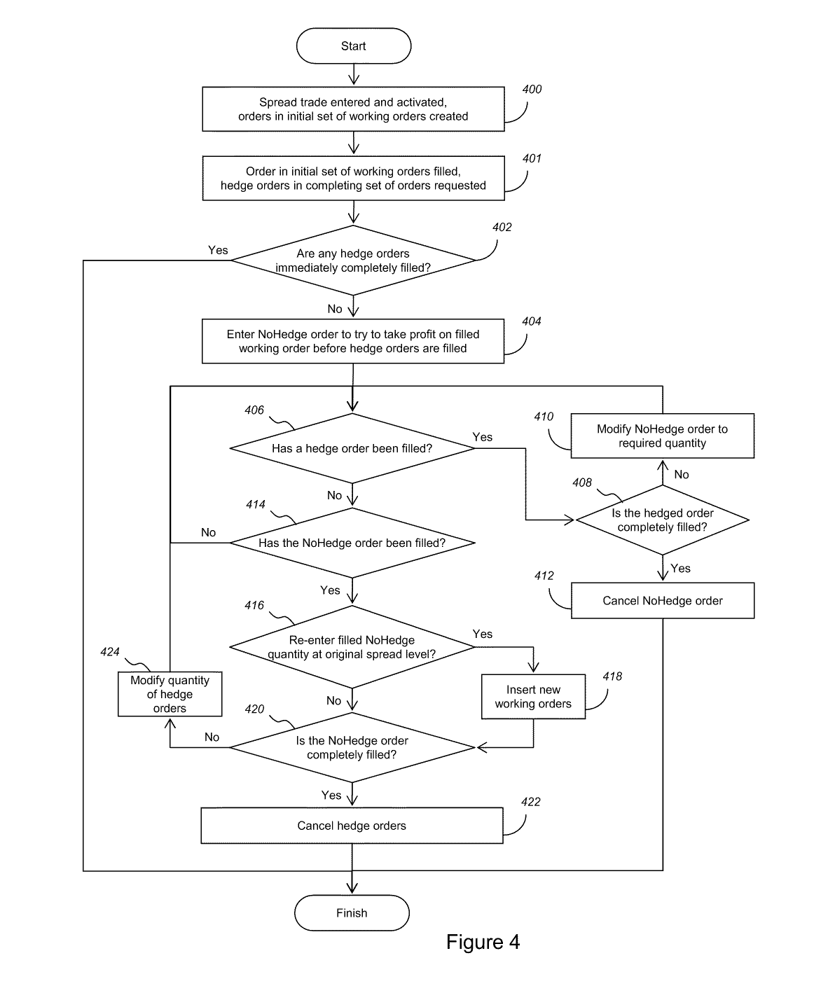

In addition as explained below and in FIGS. 4 to 6 the AST terminal 100 comprises features that allow it to rapidly execute orders or spread trades in response to the completion of previous orders and/or spread trades so as to take advantage of the volatility of trading markets. Additionally the AST terminal 100 enters response orders that the user may not notice as quickly using other automated trading systems (such as those running on the plurality of other electronic trading exchange terminals 128).

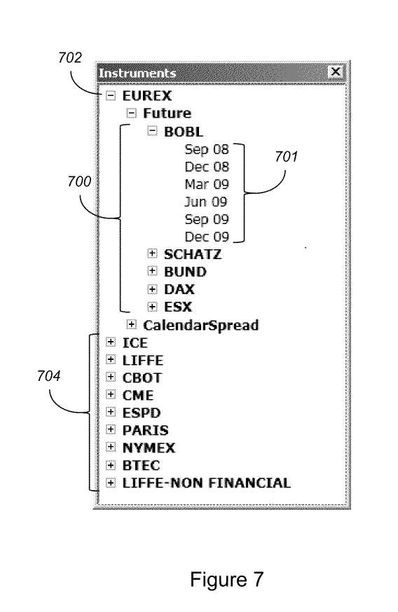

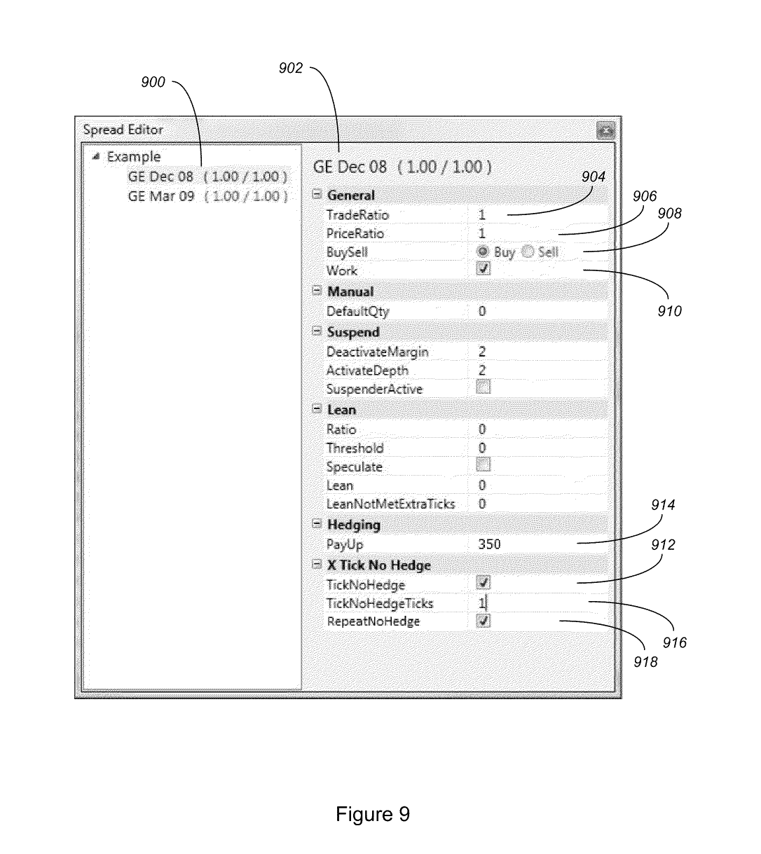

A graphical user interface is displayed to the user on the video display 118 via the graphical user interface component 112 at the AST terminal 100. FIG. 1b illustrates the steps performed to set up a spread trade and then instruct the AST terminal 100 to transmit order messages relating to the spread trade to the electronic trading exchange system 122 using this graphical user interface, and FIGS. 7 to 13 (described below) show exemplary screens of this graphical user interface. Note that the video display device(s) 118 may show a plurality of such screens simultaneously.

As illustrated in FIG. 1b, the graphical user interface component 112 first allows the user to choose whether to use an existing spread template when creating a new spread trade, or to create a new spread template (step 130). If the user wishes to create a new spread template, a list of contracts 700 with various expiry dates 701 available at various electronic exchanges 702, 704 is displayed in a screen and the user may select the contracts of the appropriate expiry dates of which the new spread template will be comprised, as shown in FIG. 7 (step 132). Each contract selected will form one of the ‘legs’ of spread trades created using the new spread template, and these selected contracts form the spread trade set of contracts, with information relating to said spread trade set of contracts being stored in the spread template.

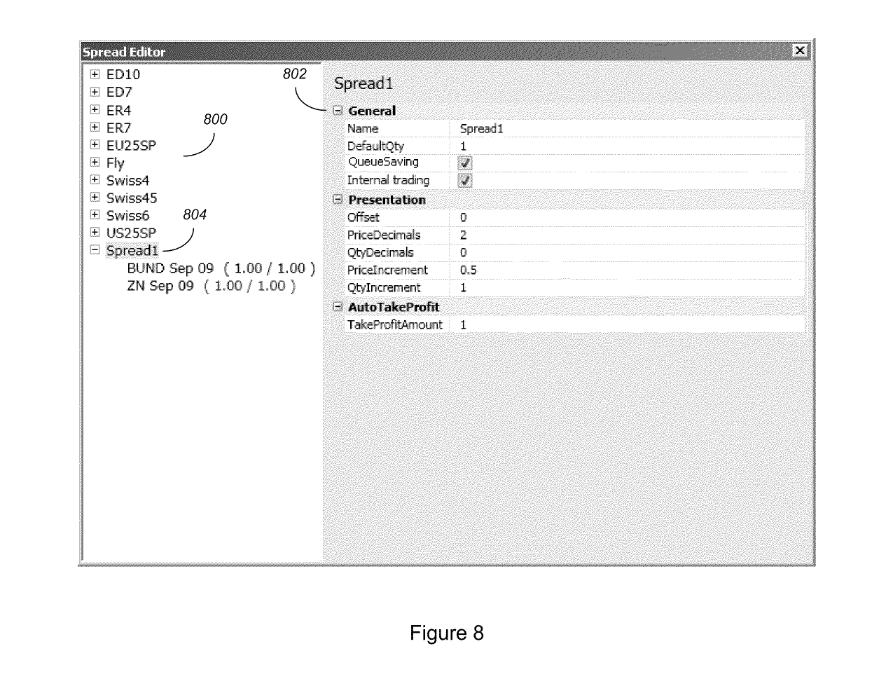

Once a spread template has been selected, for example by selecting an existing spread template 804 from the list of spread templates 800 in FIG. 8 (step 134), or a new spread template that has been created according to step 132, the user can set several parameters 802 relating to the spread template such as the name of the spread template and parameters defining the display of prices for spread trades created from the spread template.

The user may edit spread trade parameters 902 relating to each individual leg of the spread template by first selecting the leg 900 and then editing the spread trade parameters 902 for that leg. Amongst these spread trade parameters are the trade ratio 904 and price ratio of the leg 906, whether the leg may be bought or sold 908, and whether or not the leg is marked as a working leg 910. These spread trade parameters are adjusted by the user in steps 136 to 140 and their meanings are summarised below.

The pricing ratio of each leg of a spread trade is set by the user so as to equalise the correlation between the prices of the legs of the spread trade during spread price calculations, for example if the user is creating a spread template for two contracts A and B, and it is known to the user that when the price of contract A increases in value by 1 tick the price of contract B generally increases by 2 ticks, the user would set the pricing ratios pₐ and p_{b} of A and B, respectively, to pₐ=2 and p_{b}=1.

The trading ratio of each leg of a spread is set by the user so as to determine the quantity of each contract that is ordered when a spread is executed, allowing the user to try and equalise the change of value of each leg in the spread trade. For example if the user is creating a spread template for two contracts C and D, and it is known to the user that the value of one C contract is twice as much as the value of one D contract, the user would set the trading ratios t_{c} and t_{d} of C and D to t_{c}=1 and t_{d}=2, respectively (assuming equal price ratios p_{c} and p_{d} for contracts C and D).

The legs of a spread trade that have been marked as working legs in the spread template are the legs that first have orders at the electronic trading exchange system 122 created for them by the spreader component 108. By marking some of the legs of a spread template as working legs the user is able to define which contracts will have orders executed for them that form an initial set of working orders for each spread trade that is created from the spread trade template. The spreader component 108 manages these orders in this initial set of working orders so that they will be filled at a price consistent with the spread order price (or better), recent trade data and current market data known to the spreader 108. Once the spreader component 108 receives a fill confirmation message for an order in the initial set of working orders for a spread trade, the spreader 108 will instruct the hedger 110 to execute orders for the other contracts of the spread trade besides the contract to which the filled order relates. These orders or ‘hedge orders’ executed by the hedger 110 form a completing set of orders that are managed by the hedger 110 so that they will also be filled at a price consistent with the spread order price (or better), recent trade data and current market data known to the hedger 110.

In alternative embodiments of the invention the user may not mark any of the legs of a spread template as working legs in order to create a spread template for a ‘No Working Legs’ order. When a spread trade based on this spread template is executed the spreader 108 may not create an initial set of working orders, and instead orders forming a completing set of orders for all the legs of the spread trade are executed by the hedger 110, as described in further detail for the ‘No Working Legs’ order below.

In alternative embodiments of the invention the spreader 108 may not create working orders forming an initial set of working orders for the spread trade if it detects that the calculated buy/sell prices that would be used for these working orders would be immediately satisfied under current market conditions. In this case in step 204 the spreader 108 immediately instructs the hedger 110 to execute a hedge order for every leg of the spread trade in order to create a ‘Monitor Only’ order, as described in further detail below.

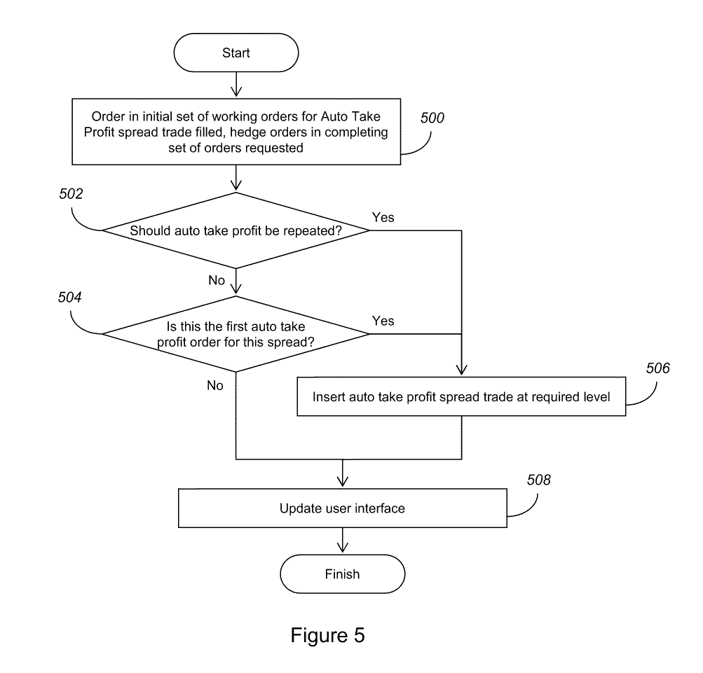

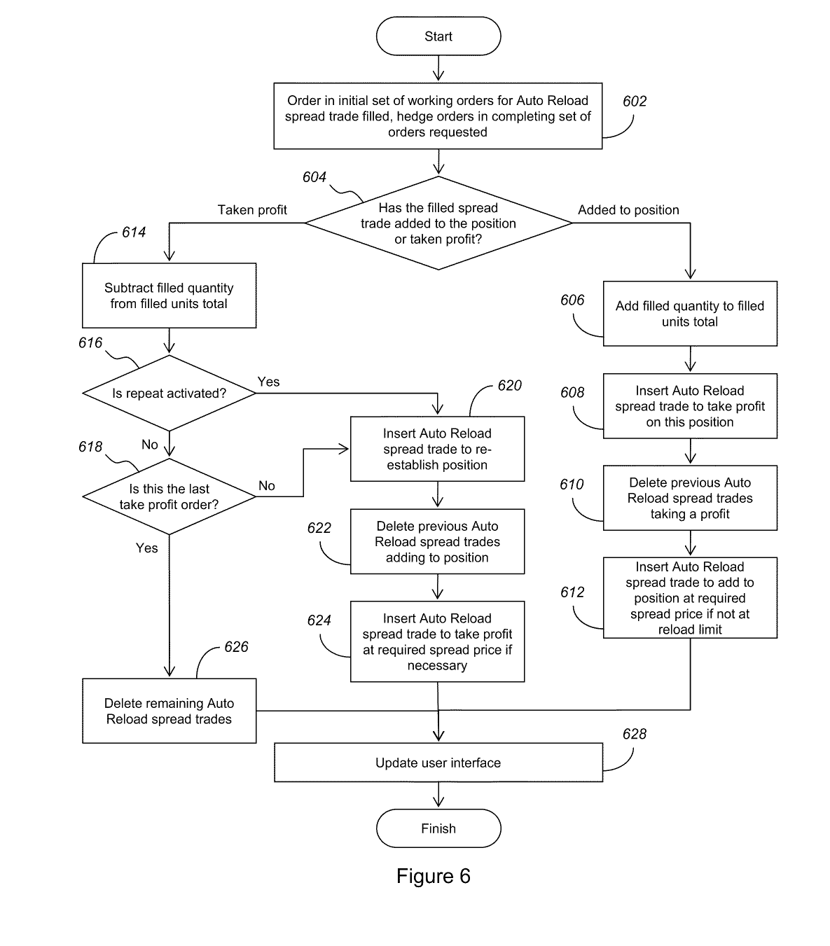

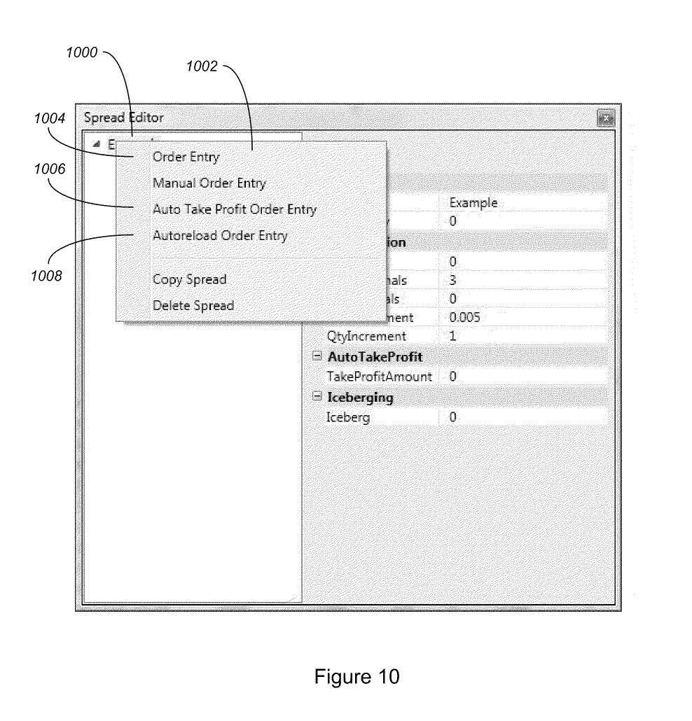

The user can then open a new on-screen interface referred to herein as a ‘ticket’ for a spread template from which new spread trades can be activated based on the settings chosen in steps 130 to 140 (step 142). FIG. 10 shows an exemplary screenshot of how the user creates a new ticket from a selected spread template 1000 by opening a ‘menu’ 1002 listing new ticket types (e.g. by clicking on that spread template in the screen shown in FIG. 10 with the right button of a mouse connected to the means for accepting user input 114) and selecting the required new ticket type 1004, 1006, 1008. Tickets are provided for a standard spread trade 1004 as well as for what will be referred to below as an ‘Auto Take Profit’ ticket 1006 and an ‘Auto Reload’ ticket 1008, each of which takes advantage of additional features of the system as illustrated in FIGS. 5 and 6 and described below.

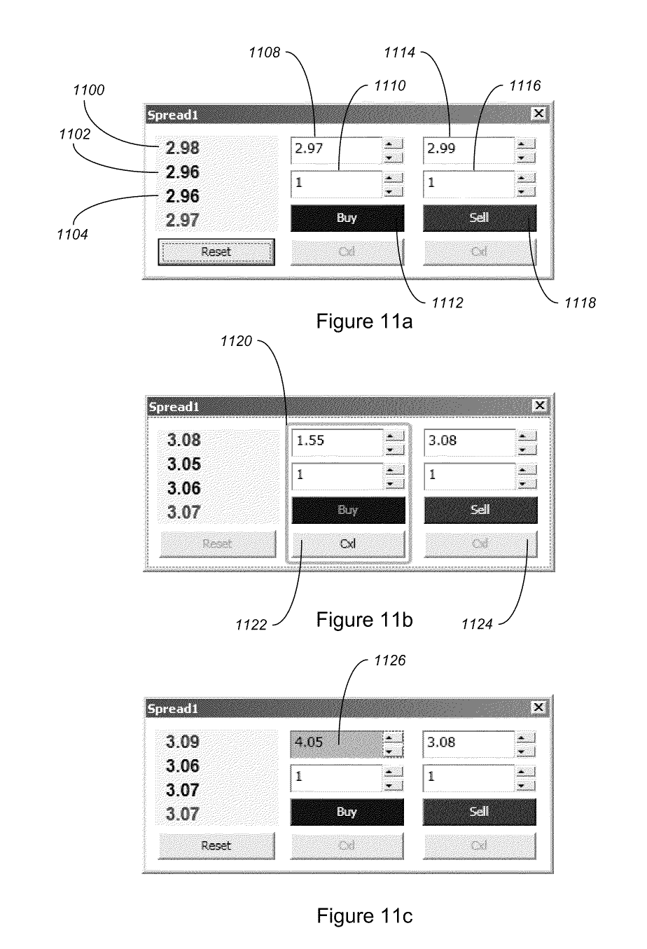

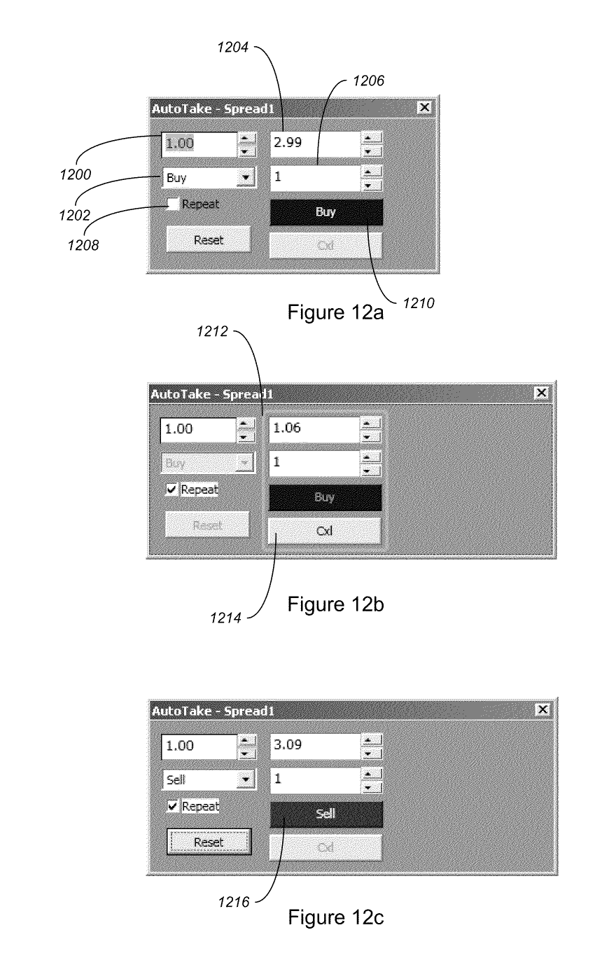

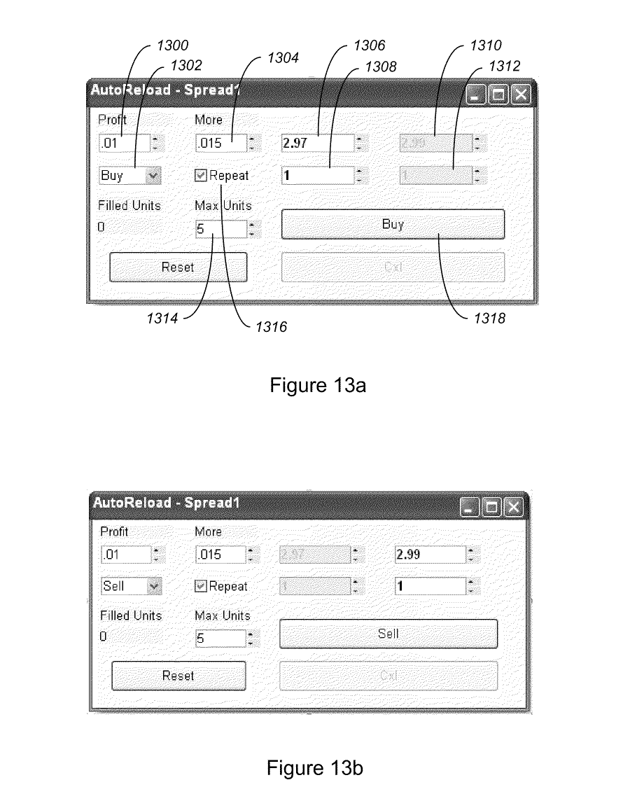

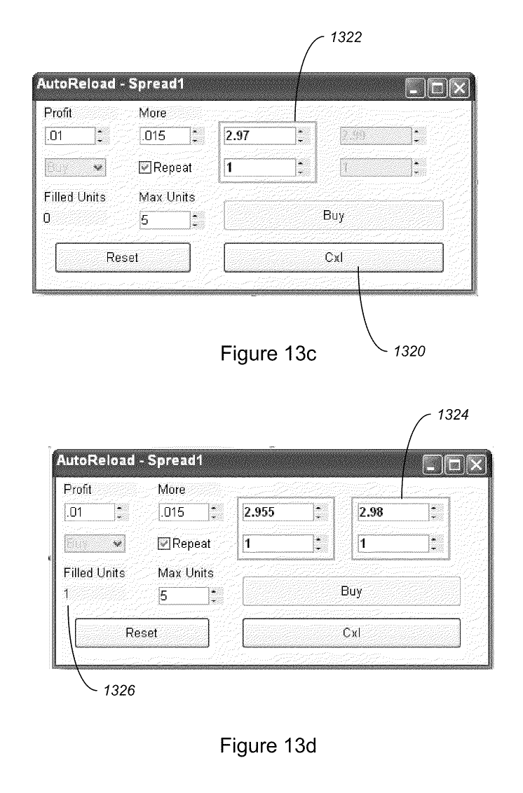

Each ticket created by the user is shown in a new window. FIG. 11a shows an exemplary screenshot of a ticket window for a standard spread trade, and FIGS. 12a and 13a show exemplary screenshots of an ‘Auto Take Profit’ ticket and an ‘Auto Reload’ ticket, respectively. Market values for the spread trade are displayed in the ticket window for a standard spread trade, indicating the lowest offer price 1100 on the market for the spread trade, the highest bid price 1102 and the price at which the spread trade was traded most recently 1104. The graphical user interface component 112 regularly uses the exchange interface 106 to request and receive recent trade data and current market data from the electronic trading exchange system 122 relating to the contracts of the legs of the spread template to which a ticket corresponds, and then updates the market values shown on the ticket window (i.e. 1100 to 1104) using this data, as summarised below.

The most recent offer price and most recent bid price for a spread trade involving legs A, B, C and D, where the spread template settings determine that legs A and C may be bought, and legs B and D may be sold are given by:

Spread offer price=(pₐ*Oₐ)−(p_{b}*B_{b})+(p_{c}*O_{c})−(p_{d}*B_{d})

Spread bid price=(pₐ*Bₐ)−(p_{b}*O_{b})+(p_{c}*B_{c})−(p_{d}*O_{d})

where pₐ . . . p_{d} are the pricing ratios of legs A to D taken from the spread template of the spread trade, Bₐ . . . B_{d} are the current highest bid prices for legs A to D, and Oₐ . . . O_{d} are the current lowest offer prices for legs A to D, respectively, where Bₐ . . . B_{d} and Oₐ . . . O_{d} are obtained from current market data. Similarly the price at which the spread trade was traded at most recently is given by:

Last traded spread price=(pₐ*Tₐ)−(p_{b}*T_{b})+(p_{c}*T_{c})−(p_{d}*T_{d})

where Tₐ . . . T_{d} are the last prices at which legs A to D were traded at most recently.

The user can then set the ‘spread order price’ which is the price at which to buy/sell a new spread trade (in the entry fields 1108 or 1114 as appropriate) created from the selected spread template, and can set a ‘quantity multiplier’ (in the entry fields 1110 or 1116 as appropriate) to determine how much of the spread trade to buy/sell (step 144).

If a spread trade of type buy could be immediately filled at the spread order price entered in field 1108 (i.e. as the entered spread order price is larger than the lowest offer price) or if a spread trade of type sell could be immediately filled at the spread order price entered in field 1114 (i.e. as the entered spread order price is smaller than the highest bid price) then the graphical user interface component 112 may indicate this in the appropriate spread order price field 1108 or 1114 by highlighting that field, as shown for the ‘buy’ spread order price 1126 in FIG. 11c.

In the ticket window for a standard spread trade illustrated in FIG. 11a the user is provided with a ‘buy’ spread trade button 1112 and a ‘sell’ spread trade button 1118. By clicking on one of these buttons the user will activate a new spread trade based on the spread template and the settings chosen (i.e. in steps 130 to 140) (step 146). If the user activates a new spread trade by pressing on the ‘buy’ spread trade button 1112, the buy/sell type of the new spread trade is set to buy so that the spreader component 108 is instructed to try to buy the spread (at the electronic trading exchange system 122) at a price consistent with the spread order price entered in 1108. Similarly if the user activates a new spread trade by pressing on the ‘sell’ spread trade button 1112, the buy/sell type of the new spread trade is set to sell so that the spreader component 108 is instructed to sell the spread (at the electronic trading exchange system 122) at a price consistent with the spread order price (or better) entered in 1114.

Thus the user can use a ticket for a standard spread trade to buy a spread at a first price 1108, and sell the same spread at a second price 1114, higher than the first price, in order to make a profit. When the user activates a new spread trade in step 146, the spreader component 108 takes the information entered by the user in steps 130 to 144 above, stores this information relating to a new spread trade as spread trade progress data 109 in RAM 104 and begins the process of submitting an initial set of working orders in order to execute the new spread trade.

The graphical user interface component 112 disables either the buy or sell button that the user has pressed on the ticket, enables a cancel button 1122 or 1124 corresponding to the buy/sell spread trade entered, and highlights that a buy or sell spread trade has been entered on a particular ticket by, for example, highlighting the buy/sell portion of the ticket with a box 1120 as shown in FIG. 11b, where a buy order has been activated on the ticket.

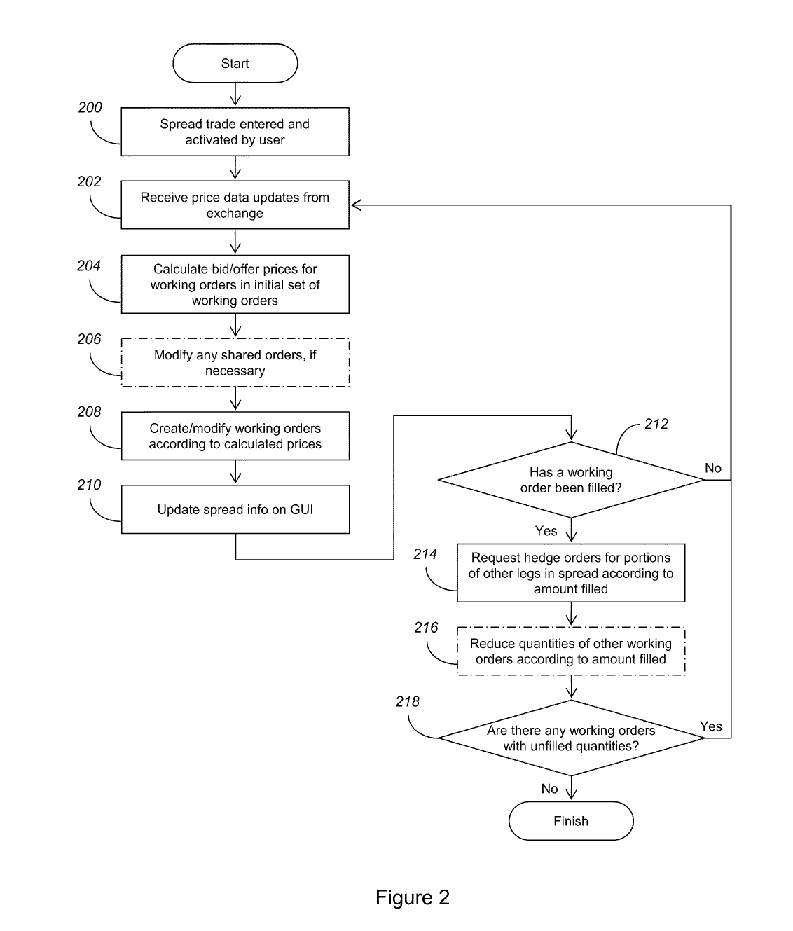

FIG. 2 illustrates the steps performed by the spreader component 108 in order to execute an initial set of working orders for a new spread trade after a new spread trade has been activated (e.g. by the user in step 146). The spreader component 108 first gathers the required information relating to the new spread trade and stores it in spread trade progress data 109 for the spread trade in RAM 104 (step 200). Information relating to the new spread trade is either gathered from a spread template along with the additional settings entered by the user into a ticket for the new spread trade, or, if the new spread trade has been requested e.g. by the spreader component 108 in response to the completion of one of the orders in the initial set of working orders in a previous spread trade relating to an ‘Auto Take Profit’ or ‘Auto Reload’ ticket, the spreader component 108 obtains information relating to the new spread trade from itself.

The spreader component 108 requires the following information in order to execute a new spread trade: a link to the spread template that determines the contracts that form the spread trade set of contracts of the new spread trade as well as settings relating to the spread trade and its legs, the buy/sell type of the new spread trade, its spread order price, and its quantity multiplier. This information is stored in spread trade progress data 109 for the spread trade in RAM 104. As the spread trade is managed by the spreader 108 and hedger 110, information relating to the progress of the spread trade is also stored in spread trade progress data 109 for the spread trade, such as the quantity required of each contract relating to the spread trade, information relating to the orders for the spread trade (which have been transmitted in the form of order messages to the electronic trading exchange system 122), information relating to the progress of these orders, such as the quantity filled on each order and the price being used for each order, and finally recent trade data and current market data received by the either the spreader 108 or the hedger 110 that relates to the contracts of the spread trade.

The spreader component 108 then selects the appropriate buy/sell type for each leg of the new spread trade according to the buy/sell type of each leg set by the user in the spread template settings and the buy/sell type of the new spread trade, and stores the buy/sell types in spread trade progress data 109 for the spread trade. If the buy/sell type of the new spread trade is set to buy each leg of the spread will be bought or sold according to the buy/sell type parameter of each leg, as set by the user in the spread template. If the buy/sell type of the new spread trade is set to sell each leg of the spread will be bought or sold using the opposite of the buy/sell type set in the for each leg in the spread template.

The spreader component 108 also calculates the quantities to use for the orders for each leg as follows, and stores this information in spread trade progress data 109 for the spread trade. For each leg X the quantity Q*tₓ of the contract of the leg will be bought/sold, where Q is the ‘quantity multiplier’ of the spread that may be bought/sold (e.g. as set by the user in entry fields 1110 or 1116), and tₓ is the trade ratio of the leg X (stored in the spread template).

The spreader component 108 then uses the exchange interface 106 to request and receive recent trade data and current market data relating to the contracts of the spread trade set of contracts of the new spread trade from the electronic trading exchange system 122, and stores this information in spread trade progress data 109 for the spread trade (step 202).

The spreader component 108 then calculates the price to use for orders in the initial set of working orders of the new spread trade in order to buy/sell the spread trade at a price consistent with the spread order price (or better), and stores this information in spread trade progress data 109 for the spread trade (step 204). The spreader component 108 uses the recent trade data and current market data received for the contracts of the spread trade set of contracts, the pricing ratios of the legs (stored in the spread template) and the spread order price to calculate the prices to use for the orders in the initial set of working orders for the spread trade. Examples follow showing the calculations used to determine the prices of the orders for working legs A and B of a spread trade involving legs A, B, C and D, where the spread template settings for the legs of the spread trade determine that the contracts for legs A and C may be bought, for legs B and D may be sold, and the legs for contracts A and B are working legs.

If the buy/sell type of the spread trade is of type buy then the buy/sell types of the legs of the spread trade are the same as defined in the spread template settings, and so the price Wₐ at which working leg A may be bought is calculated so that:

(pₐ*Wₐ)−(p_{b}*B_{b})+(p_{c}*O_{c})−(p_{d}*B_{d})≦S

is satisfied, where pₐ . . . p_{d} are the pricing ratios of legs A to D, B_{b} and B_{d} are the current highest bid prices for legs B and D respectively, obtained from current market data, O_{c} is the current lowest offer price for leg C, and S is the spread order price. Note that order prices transmitted to the electronic trading exchange system 122 may typically be integer numbers of ticks, hence Wₐ may be rounded down to the nearest tick by the spreader component 108 in order to satisfy the equation above. Similarly if the spread entered is of type buy then the price W_{b} at which working leg B may be sold is calculated so that:

(pₐ*Oₐ)−(p_{b}*W_{b})+(p_{c}*O_{c})−(p_{d}*B_{d})≦S

is satisfied, where Oₐ is the current lowest offer price for leg A. W_{b} may be rounded up to the nearest tick by the spreader component 108.

If the buy/sell type of the spread trade is of type sell then the buy/sell types of the legs of the spread trade are the opposite to what is defined in the spread template settings, i.e. legs A and C may be sold, and legs B and D may be bought. The price Wₐ at which working leg A may be sold is calculated so that:

(pₐ*Wₐ)−(p_{b}*O_{b})+(p_{c}*B_{c})−(p_{d}*O_{d})≦S

is satisfied, where O_{b} and O_{d} are the current highest bid prices for legs B and D respectively, obtained from current market data and B_{c} is the current lowest offer price for leg C. Wₐ may be rounded up to the nearest tick by the spreader component 108. Similarly if the spread entered is of type sell then the price W_{b} at which working leg B may be bought is calculated so that:

(pₐ*Bₐ)−(p_{b}*W_{b})+(p_{c}*B_{c})−(p_{d}*O_{d})≦S

is satisfied, where B_{c} is the current highest bid price for leg A. W_{b} may be rounded down to the nearest tick by the spreader component 108.

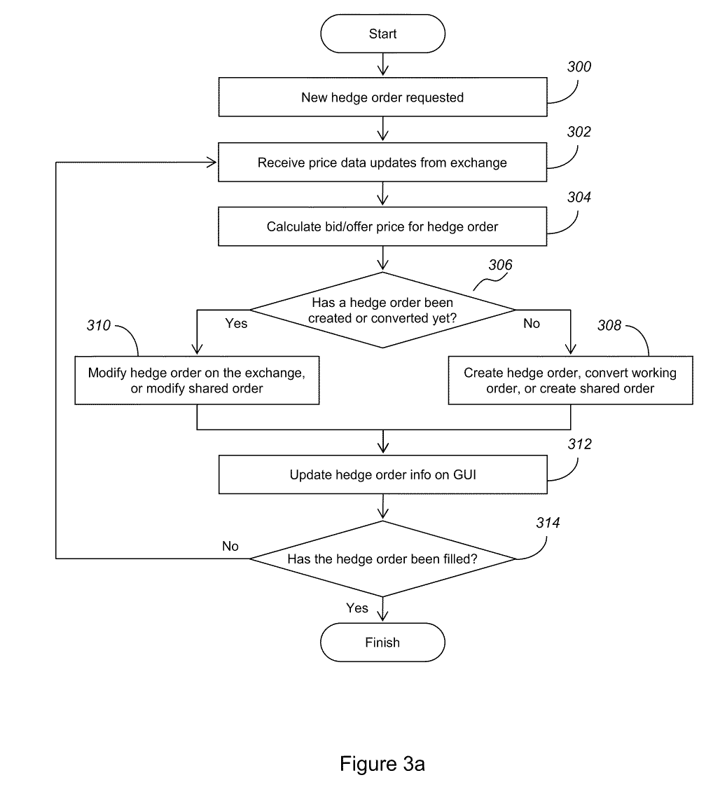

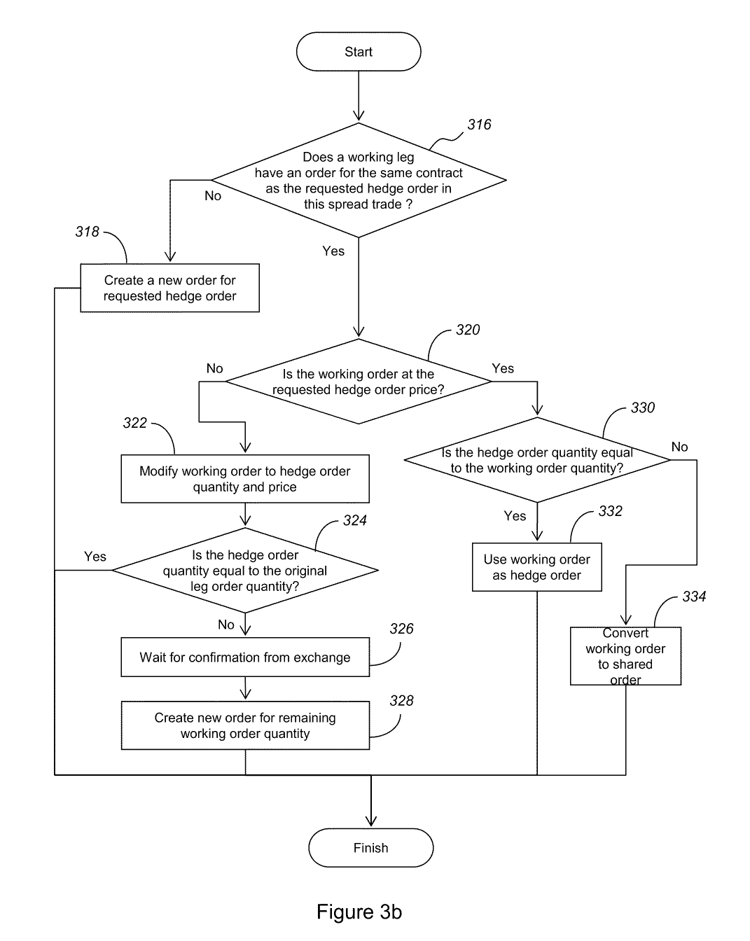

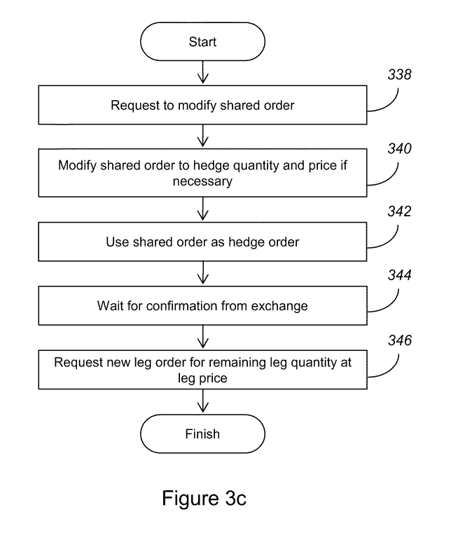

Once the prices for the orders in the initial set of working orders of the spread have been calculated in step 204, the spreader component 108 may optionally perform step 206 if the ‘Queue Saving’ feature of the AST terminal 100 is enabled, in order to modify the price of any ‘shared orders’ linked to the working legs of the spread trade. The actions performed by the spreader 108 in step 206 are illustrated in FIG. 3c and described in detail below along with the other steps performed by the AST terminal 100 in order to provide the functionality for the ‘Queue Saving’ feature.

The spreader component 108 then uses the exchange interface 106 to create a new order for each working leg at the appropriate electronic trading exchange system 122 using the determined buy and sell prices. In this way the initial set of working orders is created for the spread trade, and information relating to this initial set of working orders is stored in spread trade progress data 109 for the spread trade. If an order has already been created for a working leg in a previous iteration of steps 202 to 216, the spreader component 108 uses the exchange interface 106 to modify the existing order for each working leg to its newly calculated price (step 208).

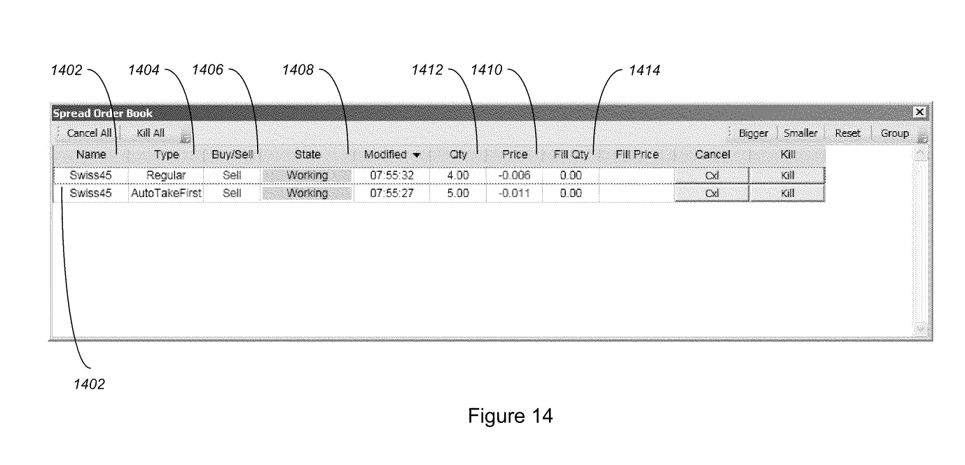

The spreader 108 will then instruct the graphical user interface component 112 to update information relating to the spread trade listed in a spread order list window, as exemplified by the screen shown in FIG. 14, where a list of spread trades 1400 is shown (step 210). Each entry in this list of spread trades 1400 corresponds to a spread trade that is being managed by the spreader 108 and hedger 110 and shows the name 1402 of the spread template on which this spread trade is based, the type of the ticket 1404 from which the spread trade was created, the buy/sell type 1406 of the spread trade, the quantity multiplier 1410 of the spread trade, the current price of the spread trade in relation to the spread order price 1412, and the quantity filled on the spread trade 1414. When the graphical user interface is instructed to update this list of spread trades 1400 it gathers the above information from the spreader 108, hedger 110 and exchange interface 106 in order to do so.

The spreader component 108 then checks whether the exchange interface 106 has received a fill confirmation message indicating that an order for a working leg of the spread trade (i.e. one of the orders in the initial set of working orders) has been ‘filled’, and if so and records this and the quantity filled (as specified in the filled confirmation message) in spread trade progress data 109 for the spread trade (step 212). An order in the initial set of working orders will be filled if another electronic trading exchange terminal 128 connected to the electronic trading exchange system 122 has entered an order that matches the order for the working leg, i.e. at a price consistent with the spread order price (or better), the recent trade data and the current market data known to the AST terminal 100.

Hence when an order in the initial set of working orders of a spread trade is filled the spread trade could be completed to satisfy the desired spread order price by immediately having orders filled for the other legs of the spread trade. Orders for the remaining legs of the spread trade may be transmitted to the electronic trading exchange system 122 immediately to take advantage of the current market for the other legs of the spread trade. This is accomplished by the spreader component 108 instructing the hedger component 110 to execute a completing set of orders at the electronic trading exchange system 122 consisting of an order message for each of the legs of the spread trade except the working order that has been filled (step 214). The spreader 108 will inform the hedger 110 of the spread trade progress data 109 to access in relation to the spread trade for which completing set of orders are to be created so that the spread trade progress data 109 for the spread trade is shared between the spreader 108 and hedger 110, or alternatively spread trade progress data 109 is passed from the spreader 108 to the hedger 110 and not shared by the two components. The spreader component 108 also informs the hedger component 110 of the identifiers of the contracts for the legs for which orders may be submitted, and, as is described below, the spreader component 108 informs the hedger component 110 of the quantity to order for each order that will form the completing set of orders. The hedger component 110 then calculates the prices of each order in the completing set of orders (each of which is referred to herein as a ‘hedge’ order), stores this information in spread trade progress data 109 for the spread trade, and then manages the orders in the completing set of orders as illustrated in the steps shown in FIG. 3a and described below.

In step 214 the fill confirmation message received by the exchange interface 106 for the filled working leg will indicate the quantity of the order that was matched. The hedger component 110 may thus be instructed to transmit order messages for the completing set of orders of the spread trade with quantities ordered according to the matched quantity of the filled working leg. The spreader component 108 calculates the quantity qₓ for the order message for an order X in the completing set of orders that is to be transmitted to the electronic trading exchange system 122 by the hedger component 110 according to:

qₓ=Fₐ/tₐ*tₓ

the result of which the spreader 108 may round up or down to the nearest integer, where Fₐ is the filled quantity of the filled working leg A, tₐ and tₓ are the trading ratios of the legs A and X, respectively, and stores this information in spread trade progress data 109 for the spread trade. Note that if the filled working leg has been completely filled then Fₐ=tₐ*Q in which case qₓ=Q*tₓ, where Q is the ‘quantity multiplier’ of the spread trade.

If the ‘Queue Saving’ feature of the AST terminal 100 is not enabled, then after the hedger component 110 has been requested to execute hedge orders for the completing set of orders, the quantities of any orders in the initial set of working orders for this spread trade managed by the spreader component 108 except the working order that has been filled may be reduced by an amount corresponding to the filled quantity of the order for the filled working leg (step 216). The spreader component 108 calculates the reduced quantity q′ₓ that may be used for the working order X in the initial set of working orders according to:

q′ₓ=qₓ−Fₐ/tₐ*tₓ

the result of which the spreader 108 may round up or down to the nearest integer, and where qₓ is the current quantity remaining on order X, and stores this information in spread trade progress data 109 for the spread trade. The spreader component 108 uses the exchange interface 106 to transmit order modification messages to the electronic trading exchange system 122 to modify the quantities of each of the orders for the initial set of working orders besides the working order that has been filled, where the modified quantities are calculated as above. If the working order that has been filled has been completely matched, then in step 216 the spreader component 108 may delete the orders for the other working orders in the initial set of working orders of the spread trade besides the one that has been filled (as the spread trade may now be entirely managed by the hedger component 110 which is managing the completing set of orders), and records this in spread trade progress data 109 for the spread trade.

If the working order that has been filled was not completely filled, that order (and orders for the other orders in the initial set of working orders if more than one working leg was marked by the user) will remain at the electronic trading exchange system 122 with an unfilled quantity, so the spreader component 108 returns to step 202 to continue receiving price updates and adjusting the prices of the orders in the initial set of working orders in order to try to achieve the required spread order price for the unfilled quantity (step 218).

Otherwise if the test in step 218 is not satisfied the spreader component 108 can finish managing this spread trade and allow the hedger component 110 to complete it. Additionally if the spread trade was created using a ticket for a standard spread trade the spreader component 108 instructs the graphical user interface 112 to re-enable the appropriate buy/sell button (1112 or 1118) on the ticket, disable the appropriate cancel button (1122 or 1124), and to remove the highlighting around the appropriate portion (e.g. 1120) of the ticket for the spread trade as shown in FIG. 11c. If the spread trade was created using an ‘Auto Take Profit’ ticket or an ‘Auto Reload’ ticket then changes made to the graphical user interface are described below.

FIG. 3a illustrates the steps performed by the hedger component 110 in order to fill a hedge order for a leg of a spread trade where that hedge order belongs to the completing set of orders of the spread trade, after one of the working orders in the initial set of working orders of the spread trade has been filled at a price consistent with the spread order price (or better), recent trade data and current market data known to the spreader 108. Firstly, the hedger component 110 receives instructions from the spreader component 108 indicating that a new order message may be required for a hedge order that forms one of the completing set of orders of the spread trade (note that the spreader component 108 will request a new hedge order for each leg of the spread trade besides the one which has just been filled, in order to form the completing set of orders) (step 300). The hedger component 110 will receive from the spreader component 108 the identifier of the contract for which a hedge order is to be placed, spread trade progress data 109 for the spread trade to which the hedge order relates, and the quantity that may be ordered.

The hedger component 110 then uses the exchange interface 106 to request and receive recent trade data and current market data relating to the contract of the requested hedge order from the electronic trading exchange system 122 (step 302). Alternatively the hedger component 110 could use the most recently received recent trade data and current market data obtained by the spreader component 108 (in step 202) relating to the contract for the requested hedge order. The hedger component 110 then uses the recent trade data and current market data received for the contract of the requested hedge order to calculate the price at which this order may be bought or sold, depending on the buy/sell instructions from the spreader component 108 (step 304). The hedger 110 calculates the price for the hedge order for the leg for which a hedge order has been requested as follows. If the spread trade progress data 109 for the spread trade indicates that the hedger component 110 should enter a buy order for the leg, the hedger component 110 uses the lowest offer price known from current market data as the buy price for that order. If the spread trade progress data 109 for the spread trade indicates that the hedger component 110 should enter a sell order for the leg, the hedger component 110 uses the highest bid price known from current market data as the sell price for that order.

Alternatively the hedger component 110 could try and buy/sell the contract for the requested hedge order at a better price than is currently offered on the market, in order to obtain a better position or profit for the user. In this case when calculating the price for the order for this leg, if the buy/sell type of the leg is of type buy, the hedger component 110 uses the price 1 tick less than the lowest offer price known from current market data as the buy price for the order, unless current market data indicates that the quantity offered at the lowest offer price is less than a ‘PayUp’ threshold set by the user in the spread template in field 914 in which case the lowest offer price is used. Similarly if the buy/sell type of this leg is of type sell, the hedger component 110 uses the price 1 tick more than the highest bid price known from current market data as the sell price for the order for this leg, unless current market data indicates that the quantity bid at the highest bid price is less than the ‘PayUp’ threshold 914 in which case the highest bid price is used.

Once the buy/sell price for the requested hedge order has been calculated in step 304 according to one of the methods described above, the hedger component 110 stores the calculated buy/sell price for the requested hedge order in spread trade progress data 109 for the spread trade and will then check whether an order has been created for the requested hedge order yet (step 306) and if not will do so by proceeding to step 308.

In step 308 the hedger component 110 uses the exchange interface 106 to create a new order at the appropriate electronic trading exchange system 122 for the hedge order that has been requested, where the order is for the contract of the requested hedge order, is of the determined buy/sell type and the requested quantity, and is given the buy/sell price determined by the hedger 110 in step 304.

Alternatively if the ‘Queue Saving’ feature is enabled for the spread trade using the appropriate setting 802 in the spread trade template then if in step 308 the leg for which a hedge order is requested has a corresponding working order the hedger 110 may use that order as the new hedge order, or may attempt to ‘share’ that order with the spreader 108 in order to create a ‘shared order’. In this case the actions performed by the hedger 110 in step 308 are illustrated in FIG. 3b and described in detail below along with the other steps performed by the AST terminal 100 in order to provide the functionality for the ‘Queue Saving’ feature.

If a hedge order has already been created for the leg in a previous iteration of steps 302 to 314, the hedger component 110 uses the exchange interface 106 to modify the existing hedge order for the leg to its newly calculated price from step 304 by transmitting an order modification message specifying the new price to the electronic trading exchange system 122 (step 310).

Alternatively if the ‘Queue Saving’ feature is enabled and this leg is linked to a shared order then in step 310 the hedger 110 will modify the ‘shared order’ if appropriate. In this case the actions performed by the hedger 110 in step 310 are illustrated in FIG. 3c and described in detail below along with the other steps performed by the AST terminal 100 in order to provide the functionality for the ‘Queue Saving’ feature.

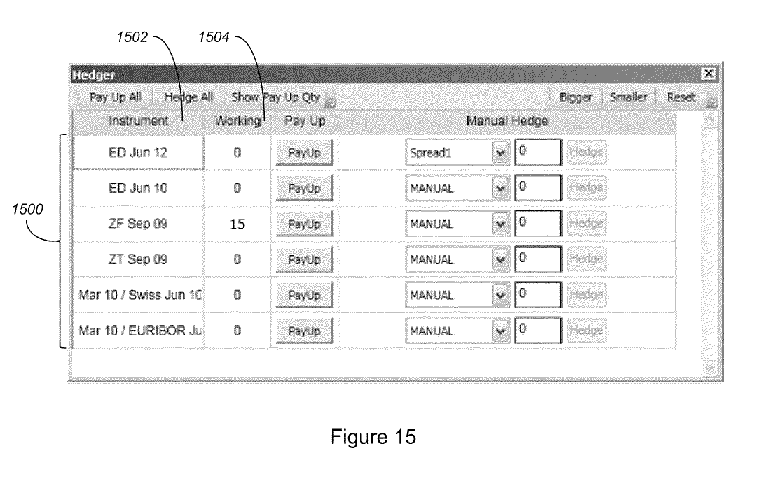

The hedger 110 will then instruct the graphical user interface component 112 to update information relating to the hedge order listed in the hedge orders list, as exemplified by the screen shown in FIG. 15, where a list of potential hedge orders 1500 is shown (step 312). Each entry in this list of potential hedge orders 1500 relates to potential hedge orders managed by the hedger 110 and shows the name of the contract 1502 to which the hedge orders relate, the total quantity of these hedge orders 1504 that are being managed by the hedger 110.

The hedger component 110 then checks whether the exchange interface 106 has received a fill confirmation message indicating that the hedge order for the leg has been filled, i.e. matched at the electronic trading exchange system 122, and if so records this and the amount filled (as specified by the fill confirmation message) in spread trade progress data 109 for the spread trade (step 314). If the hedge order has not been filled then the hedger component 110 may try to buy/sell the leg at a better price than is currently offered on the market as described above by returning to step 302 in order to receive recent trade data and current market data updates from the electronic trading exchange and modify the hedge order price according to these. If in step 314 the hedger 110 has received a fill confirmation message indicating that the hedge order for the leg has been filled, the hedger 110 instructs the graphical user interface 112 to update the hedge orders list shown in FIG. 15 with information relating to the fill of the hedge order.

In alternative embodiments of the invention the hedger 110 may not return to step 302 if a hedge order has not been filled and may instead wait at step 314 until the hedge order is filled, without modifying the price of the hedge order further.

Once the hedger component 110 has completely filled all of the hedge orders of a spread trade (i.e. all the orders in the completing set of orders for the spread trade requested by the spreader 108) the spread trade is complete. The hedger 110 instructs the graphical user interface component 112 to update the spread trades list shown in FIG. 14 with information relating to the completion of the spread trade.

As summarised above the AST terminal 100 provides a ‘Queue Saving’ feature that a user can enable by using the settings 802 in the spread template for a spread trade. With the ‘Queue Saving’ feature enabled for a spread trade, when an order in the initial set of working orders of a spread trade managed by the spreader 108 is filled and the hedger 110 is requested to create hedge orders for the remaining legs corresponding to the completing set of orders of the spread trade, if the hedger 110 is requested to create a hedge order for a leg that has a working order in the initial set of working orders, the hedger 110 may use that order as the new hedge order, or may attempt to ‘share’ that order with the spreader 108 in order to create a ‘shared order’.

In this way, the queue position in the order matching system 124 of the working orders in the initial set of working orders of the spread trade that have not been filled is preserved for the hedge orders in the completing set of orders that are created for the legs of these working orders. This allows the user of the AST terminal 100 to gain an advantage over other terminals 128 that may lose their queue position at the electronic trading exchange system 122 because they first cancel unfilled orders for the unfilled working legs of a spread trade before creating new orders to hedge the same legs. By avoiding this using the ‘Queue Saving’ feature the user of the AST terminal 100 is also able to reduce the bandwidth consumed on the communications network 126. A performance advantage is also gained over other terminals that may wait for confirmation that an order for an unfilled working leg has been cancelled before creating a corresponding hedge order so as to avoid the possibility of both the order for the unfilled working leg and the corresponding hedge order being filled and causing a user to buy/sell more of a contract than desired (i.e. what is known as a ‘double fill’). The ‘Queue Saving’ feature of the AST terminal 100 ensures that the user can only ever get filled on the desired amount of the leg of a spread trade, and avoids the delay of cancelling and then creating a new order when a new hedge order is requested.

When the ‘Queue Saving’ feature of the system is enabled, the hedger 110 creates or converts orders or shared orders for hedge orders in step 308 according to the steps illustrated in FIG. 3b, described below. If an existing order for a working leg is used as a shared order, that order is modified according to the steps shown in FIG. 3c if it becomes necessary for the spreader 108 to modify the price of a working leg in step 206 or the hedger 110 to modify the price of a hedge order in step 310. It is not necessary for the spreader 108 to perform step 216 when the ‘Queue Saving’ feature is enabled. If a shared order is filled, either the spreader 108 or hedger 110 may be assigned the filled portion of the shared order, as is described in detail below.

FIG. 3b illustrates an alternative set of steps performed by the hedger component 110 in order to create or convert an order or shared order for a new hedge order in step 308 of FIG. 3a when the ‘Queue Saving’ feature of the AST terminal 100 is enabled.

The hedger 110 first checks the spread template for the new hedge order so as to determine whether the leg to which the requested new hedge order belongs is marked as a working leg, and if so the hedger 110 then checks spread trade progress data 109 for the spread trade in order to determine whether that working leg has a working order in the initial set of working orders for that spread trade (step 316). If not, the hedger 110 uses the exchange interface 106 to create a new order at the appropriate electronic trading exchange system 122 for the hedge order that has been requested, where the order is for the contract of the requested hedge order, is of the determined buy/sell type and the requested quantity, is given the buy/sell price determined by the hedger 110 in step 304 (step 318), and the hedger 110 then continues to manage the new hedge order as normal according to the steps illustrated in FIG. 3a, after storing this information in spread trade progress data 109 for the spread trade.

Otherwise if the tests in step 316 are satisfied, the hedger 110 will either use the order for the working leg as the order for the hedge order, or convert the order for the working leg into a shared order by performing the remaining steps illustrated in FIG. 3b. The hedger 110 will first check spread trade progress data 109 for the spread trade in order to determine if the price value of the order for the working leg is the same as the price that has been determined by the hedger 110 in step 304 for the requested hedge order (step 320).

If the test in step 320 is not satisfied, the hedger 110 will use the exchange interface 106 to transmit an order modification message to the electronic trading exchange system 122 in order to change the price of the order for the working leg to the price determined for the new hedge order, and to change the quantity of the order for the working leg to the quantity requested for the new hedge order (step 322).

The hedger 110 then checks whether the quantity requested for the new hedge order is equal to the quantity that remained on the order for the working leg prior to step 322 (step 324). If this is the case, an order is no longer needed for the working leg, as another working order in the set of working orders for the spread trade must have been completely filled in order for a new hedge order of the requested quantity to have been requested. The hedger 110 can thus assume responsibility for the order for the working leg and treat it as the order for the requested hedge order, i.e. as one of the completing set of orders for the spread trade. This order is then managed by the hedger 110 as normal according to the steps in FIG. 3a. The spreader 108 will be instructed by the hedger 110 to mark the order for the working leg as cancelled (in the spread trade progress data 109 for the spread trade) and so the spreader 108 may no longer manage the working leg.

If in step 324 the hedger 110 determined that the quantity requested for the new hedge order was not equal to the quantity that remained on the order for the working leg then an order is still needed for the working leg, as none of the initial set of working orders of the spread trade have been completely filled. The hedger 110 thus waits until the exchange interface 106 has received an order modification confirmation data message in response to the order modification message transmitted to the electronic trading exchange system 122 before proceeding (step 326). Once this confirmation has been received, the hedger 110 instructs the spreader 108 to use the exchange interface 106 to create a new order for the working leg of spread trade which will form one of the initial set of working orders of the spread trade and will replace the working order that has been transferred to the hedger 110 (step 328). The price of the new order for the working leg will be the price used for the previous order for the working leg before it was modified in step 324, and the quantity of the new order will be the quantity used for the previous order subtracted by the quantity requested for the new hedge order. The spreader 108 will store this information in spread trade progress data 109 for the spread trade and then manage the new order for the working leg as normal according to the steps illustrated in FIG. 2, whilst the hedger 110 will manage the converted hedge order as normal according to the steps in FIG. 3a.

If in step 320 the hedger 110 determined that the price value of the order for the working leg was the same as the price that had been determined by the hedger 110 in step 304 for the requested hedge order, the hedger will first check if the quantity requested for the new hedge order is equal to the quantity of the order for the working leg (step 330). If this is the case, an order is no longer needed for the working leg, as another working order in the set of working orders for this spread trade must have been completely filled in order for a new hedge order of the requested quantity to have been requested. The hedger 110 can thus assume responsibility for the order for the working leg and treat it as the order for the requested hedge order, i.e. as one of the completing set of orders for the spread trade. This order is then managed by the hedger 110 as normal according to the steps in FIG. 3a. The spreader 108 will be instructed to mark the order for the working leg as cancelled (in the spread trade progress data 109 for the spread trade) and so may no longer manage this working leg.

If in step 330 the hedger 110 determined that the quantity requested for the new hedge order was not equal to the quantity of the order for the working leg, the hedger 110 converts the order for the working leg into a ‘shared order’ by setting a shared order flag for the order in the spread trade progress data 109 for the spread trade (step 334). In this way both the working leg and the requested hedge order are linked to this shared order. The hedger 110 informs the spreader 108 of the quantity of the shared order that is required for the new hedge order and records this quantity in the spread trade progress data 109 for the spread trade, and the spreader 108 marks the remaining quantity of the shared order besides that required for the new hedge order as required for the working leg. The order is thus shared by the spreader component 108 (which uses its portion of the order as the order for the working leg) and by the hedger component 110 (which uses its portion of the order as the requested new hedge order), who both continue to manage the working order and requested hedge order as normal according to FIG. 2 and FIG. 3a, except that if either component wishes to modify the price of the shared order or if a fill occurs on the shared order the procedures outlined below are followed.

FIG. 3c shows the steps that may be performed by either the spreader 108, or the hedger 110, if either of these components requests to modify the price of a shared order in step 206 or step 310, respectively.

Firstly, a request to modify the price of a shared order is either made by the spreader 108 to itself (if the spreader 108 wishes to change the price of a shared order in step 206) or is made by the hedger 110 to the spreader 108 (if the hedger 110 wishes to change the price of a shared order in step 310) (step 338).

If it is the hedger 110 that has made a request to the spreader 108 to modify the price of a shared order, the spreader 108 uses the exchange interface 106 to transmit an order modification message to the electronic trading exchange system 122 in order to change the price of the shared order to the price requested by the hedger 110 for the hedge order, and to change the quantity of the shared order to the quantity that the spreader 108 was informed was required for the hedge order in step 334 (step 340). If it is the spreader 108 that has made a request to itself to modify the shared order, the spreader 108 uses the exchange interface 106 to transmit an order modification message to the electronic trading exchange system 122 in order to change the quantity of the shared order to the quantity that the spreader 108 was informed was required for the hedge order in step 334, but the price of the shared order is kept the same as the shared order is still at the price required for the hedge order.

The shared order is now suitable for use by the hedger 110 as the hedge order, i.e. as one of the completing set of working orders for the spread trade, and the changes made to this order are recorded by the spreader 108 in spread trade progress data 109 for the spread trade (step 342). The converted hedge order is managed as normal according to FIG. 3a by the hedger 110.

The spreader 108 then waits for the exchange interface 106 to receive confirmation in the form of an order modification confirmation data message that the order modification message sent in step 340 has been processed by the electronic trading exchange system 122 (step 344). The spreader 108 then uses the exchange interface 106 to transmit a new order to the electronic trading exchange system 122 to use for the working leg that the shared order was linked to which will form one of the initial set of working orders of the spread trade and will replace the working order that has been transferred to the hedger 110 and stores information relating to this new order in spread trade progress data 109 for the spread trade (step 346). The new order is for the same contract and has the same buy/sell type as the shared order, but is for the quantity that was marked as required for the working leg in step 334. If it was the hedger 110 that requested that the shared order be modified in step 338, the price of the new order should be the same as that of the shared order before it was modified in step 340, otherwise if it was the spreader 108 that requested that the shared order be modified in step 338, the price of the new order is set to the price requested by the spreader 108 (i.e. which was determined in step 204).

The new order is then treated as the order for the working leg to which the shared order had been linked, and is managed as normal by the spreader 108 according to FIG. 2.

If a shared order is filled before either the spreader 108 or the hedger 110 attempts to modify the price of the shared order according to the steps shown in FIG. 3c, the filled quantity on the shared order may be prioritised by the spreader 108 to either the hedge order or to the working leg linked to the shared order. For example, a fill on a shared order may be prioritised by the spreader 108 so that the filled quantity is assigned to the hedge order linked to the shared order first, and, if the hedge order is completely filled, the remaining filled quantity on the shared order is assigned to the working leg linked to the shared order. Alternatively a fill on a shared order may be prioritised by the spreader 108 so that the filled quantity is assigned to the working leg linked to the shared order first, and, if the working leg is completely filled, the remaining filled quantity on the shared order is assigned to the hedge order linked to with the shared order. Alternatively the filled quantity on the shared order could be split evenly by the spreader 108 between the working leg and the hedge order, or split between the two by the spreader 108 on a pro-rata basis.

When a fill on a shared order occurs, the filled quantities on both the hedge order and the working leg are managed as normal by the hedger 110 in step 314 and spreader 108 in step 212, respectively. If the hedge order linked to the shared order is completely filled by a fill on the shared order, the shared order is converted back into an order for the working leg by the spreader 108 and the remaining quantity on that order is then managed as normal by the spreader 108 according to the steps in FIG. 2. If the working leg linked to the shared order is completely filled by a fill on the shared order, the shared order is converted into an order for the hedge order by the spreader 108 and the remaining quantity on that order is then managed as normal by the hedger 110 according to the steps in FIG. 3a. If both the hedge order and the working leg are completely filled by a fill on the shared order both the hedger 110 and spreader 108 manage these fills as normal according to steps 314 and 212 respectively and both finish managing the shared order.

The use of an AST terminal 100 to execute spread trades as described above can benefit a user as the AST terminal 100 can react immediately upon receiving recent trade data or current market data from the electronic trading exchange system 122 indicating that market conditions have become suitable to perform a spread trade, whereas a user executing the individual orders of a spread trade manually may miss the suitable market conditions due to the time required for a trading terminal to display the changes in the market on a graphical user interface, and for the user to notice these change and react to them appropriately.

The AST terminal 100 is also able to react to volatility in a market that it would not be possible to display to a user when rapid changes occur that the AST terminal 100 would not have time to display on the graphical user interface. As the AST terminal 100 does not need to display the changes in the market on the graphical user interface and wait for a response from the user, the AST terminal 100 is able to offer a processing speed advantage in comparison to other electronic trading terminals.

In order to react to volatility in a market the AST terminal 100 may offer any combination of three methods which are referred to herein as ‘Tick No Hedge’, ‘Auto Take Profit’ and ‘Auto Reload’ that can be activated by the user in order to automatically enter additional orders or spread trades in response to the completion of other orders or spread trades. The steps of these methods are illustrated in FIGS. 4 to 6 and described below.

The ‘Tick No Hedge’ feature of the AST terminal 100 is activated by the user by enabling the ‘Tick No Hedge’ settings 912 for one or more of the working legs of a spread template. If this feature is activated, the spreader component 108 will create a ‘NoHedge’ order for a working leg in the spread trade that has ‘Tick No Hedge’ enabled, if the spreader component 108 finds that the working order for that leg (i.e. the order for that leg in the initial set of working orders for the spread trade) has been filled in accordance with the steps shown in FIG. 2, i.e. in step 212. The ‘NoHedge’ order is created by the spreader component 108 at the same time as the hedger component 110 is requested to execute hedge orders that form the completing set of orders for the spread trade in response to the fill on the working leg. Information relating to the ‘NoHedge’ order is recorded by the spreader 108 in spread trade progress data 109 for the spread trade and accessed during the steps shown in FIG. 4 described below in order to manage the ‘NoHedge’ order. The ‘NoHedge’ order is configured so that it is filled if the market for the contract of the filled (or partially filled) working leg changes such that that contract could be bought/sold back at a profit.

For example, if a buy order for working leg A of a spread trade comprising legs A, B and C is filled at the price of 20, then a ‘NoHedge’ order is immediately created by the spreader component 108 that attempts to sell the same contract as leg A for the price of 22 (assuming that a ‘Tick No Hedge Ticks’ value is set to 2 by the user in field 916 of the spread template settings for the working leg), at the same time as the hedger component 110 is requested to execute hedge orders for legs B and C in response to the fill on leg A.

If the ‘NoHedge’ order is filled all of the orders in the completing set of orders of the spread trade are cancelled and the spread trade may be optionally restarted by the spreader component 108, if the user has set a ‘Repeat No Hedge’ setting 918 in the spread template settings for the working leg to which the ‘NoHedge’ order corresponds. If one of the orders in the completing set of orders is filled before the ‘NoHedge’ order is filled the ‘NoHedge’ order is cancelled and the spread trade is completed by the hedger component 110 according to the steps illustrated in FIG. 3a, as normal.

The ‘Tick No Hedge’ feature thus allows the user to take advantage of volatility in the market for the contract of a working leg of a spread trade. If the market price of that contract is fluctuating rapidly, the AST terminal 100 can make a profit on the contract instead of completing a spread trade. As the order message for the ‘NoHedge’ order is transmitted to the electronic trading exchange system 122 by the spreader component 108 as soon as the order in the initial set of working orders is filled and without needing to display this fill or wait for input from the user, the AST terminal 100 gains a significant processing advantage over existing spread trading terminals.

FIG. 4 illustrates additional steps performed by the spreader component 108 in order to execute a spread trade with ‘Tick No Hedge’ settings enabled for at least one of the working legs of the spread trade. Firstly, the user enters and activates a new spread trade using a ticket for a standard spread trade according to the steps shown in FIG. 1b, the spreader component 108 then transmits order messages for the working legs of the spread trade to the electronic trading exchange system 122 in order to create the initial set or working orders according to steps 200 to 208 in FIG. 2 (step 400). At some point later an order in the initial set of working orders that is for a working leg that has ‘Tick No Hedge’ enabled is filled and the spreader component 108 instructs the hedger component 110 to execute order messages for all the legs of the spread except the working leg that has been filled in order to create the completing set of orders for the spread trade, according to steps 210 to 212 (step 401). The hedger component 110 then transmits and manages order messages to create the completing set of orders for the spread trade, according to the steps in FIG. 3a.

Once the hedger component 110 has transmitted hedge orders for the completing set of orders to the electronic trading exchange system 122, the spreader component 108 queries the hedger component 110 to check whether any of these hedge orders have immediately been completely filled at the electronic trading exchange system 122 (step 402). If any of the hedge orders in the completing set of orders have been completely filled then the spreader component 108 performs none of the further steps in FIG. 4 and continues as normal according to FIG. 2.

If none of the hedge orders in the completing set of orders have been completely filled then the spreader component 108 uses the exchange interface 106 to send an order message to enter a new order at the electronic trading exchange system 122 which is a ‘NoHedge’ order (step 404). This NoHedge order is an order for the same contract as that of the filled order in the initial set of working orders (the ‘filled working order’), with the quantity ordered the same as the quantity that was filled on the filled working order. If the filled working order was a buy order then the spreader component 108 creates the ‘NoHedge’ order as a sell order, whereas if the filled working order was a sell order then the spreader component 108 creates the ‘NoHedge’ order as a buy order, hence the ‘NoHedge’ order may be referred to as an ‘opposing’ order to the filled working order. The price at which the NoHedge order is to be bought or sold is determined according to the price at which the filled working order was filled and according to a user-defined offset value called ‘Tick No Hedge Ticks’ 916 that is part of the ‘Tick No Hedge’ parameters for the filled working order.

If the NoHedge order is a buy order, then the price of the NoHedge order will be the price of the filled working order subtracted by the user-defined offset value 916, whilst if the NoHedge order is a sell order, then the price of the NoHedge order will be the price of the filled working order added to the user-defined offset value 916. In this way the user-defined offset value determines the number of ticks lower than the price of the buy order is than the price of the sell order (where one of these orders is the filled working order, and the other is the NoHedge order), in order to allow the user to make a profit on the filled working order if the NoHedge order is filled.

Once the spreader component 108 has transmitted the NoHedge order to the electronic trading exchange system 122 in step 404, it proceeds to manage the NoHedge order whilst communicating with the hedger component 110 as illustrated in steps 406 to 424 and described below. The spreader component 108 first queries the hedger component 110 in order to check whether a fill has occurred for any of the hedge orders in the completing set of orders at the electronic trading exchange system 122 (step 406). If a hedge order in the completing set of orders has been filled the spreader component 108 queries the hedger component 110 in order to check if the order has been completely filled (step 408), and if it has the spreader component 108 uses the exchange interface 106 to transmit an order cancellation message in order to cancel the NoHedge order at the electronic trading exchange system 122 (step 412) and then continues as normal according to FIG. 2. If in step 408 the spreader component 108 finds that the filled hedge order in the completing set of orders has not been completely filled the spreader component 108 uses the exchange interface 106 to transmit an order modification message to the electronic trading exchange system 122 in order to reduce the quantity of the NoHedge order by an amount corresponding to the amount filled on the filled hedge order (step 410). The spreader component 108 may calculate the reduced quantity q′_{NH} used for the NoHedge order according to:

q′_{NH}=t_{NH}*(Q−max(F_{hedge}/t_{hedge}))

the result of which the spreader 108 may round up or down to the nearest integer, where max(F_{hedge}/t_{hedge}) returns the largest proportion filled on any of the filled hedge orders in the completing set of orders that were created by the hedger component 110 in step 400, t_{NH} is the trading ratio of the NoHedge order, which is the same as the trading ratio of the leg of the filled working order, and Q is the ‘quantity multiplier’ of the spread trade. The above calculation ensures that the NoHedge order is only operating on an equivalent portion of the spread trade that has not been filled in any hedge order in the completing set of orders. Once the order modification message reducing the quantity of the NoHedge order has been transmitted, the spreader component 108 returns to step 406.

If at step 406 the spreader component 108 found that no fill has occurred for any of the hedge orders in the completing set of orders, the spreader component 108 checks whether the exchange interface 106 has received order completion data indicating that the NoHedge order has been ‘filled’ (step 414). If not the spreader component 108 returns to step 406, but otherwise the spreader component 108 will check the ‘RepeatNoHedge’ parameter 912 of the leg of the spread trade set by the user during step 140 to determine whether the spread trade may be ‘restarted’, i.e. a new set of initial working orders with quantities equivalent to the filled NoHedge quantity may be created for the spread trade (step 416). If so the spreader component 108 uses the exchange interface 106 to transmit to the electronic trading exchange system 122 new orders for each of the legs of the spread trade that have been marked by the user as working legs in order to create a new set of initial working orders. These new working orders in the new set of initial working orders are given the same buy/sell type as the working orders in the initial set of working orders that were first submitted by the spreader component 108 for this spread trade in step 208, and are given quantities equivalent to the quantity that has been filled on the NoHedge order (step 418). The spreader component 108 may calculate the quantity q_{wx} used for the new order for working leg X according to:

q_{wx}=F_{NH}/N_{H}*t_{wx}

the result of which the spreader 108 may round up or down to the nearest integer, where F_{NH} is the quantity filled on the NoHedge order, t_{NH} is the trading ratio of the NoHedge order which is the same as the trading ratio of the filled working leg in step 400, and t_{wx} is the trading ratio of working leg X.

The prices of the new working orders in the new set of initial working orders are determined according to steps 202 and 204, and the spreader component 108 manages these working orders as normal according to the steps illustrated in FIG. 2. Note that if one of the new working orders in the new set of initial working orders is filled and ‘NoHedge’ is enabled for the working leg whose order is filled, the spreader component 108 will once again return to step 400 and enter another NoHedge order, and then continue with the steps illustrated in FIG. 4 for this new NoHedge order.

After steps 416 and 418, the spreader component 108 checks whether the NoHedge order has been completely filled (step 420), and if it has it instructs the hedger component 110 to cancel the hedge orders in the completing set of orders of the spread trade at the electronic trading exchange (step 422), at which point the spreader component 108 has finished dealing with this NoHedge order.

If at step 420 the spreader component 108 determined that the NoHedge order has not been completely filled, then the spreader component 108 instructs the hedger component 110 to transmit order modification messages to the electronic trading exchange system 122 in order to reduce the quantities of the hedge orders in the completing set of orders by an amount corresponding to the quantity filled on the NoHedge order. The hedger component 110 may calculate the reduced quantity q′ₓ used for the hedge order for leg X according to:

q′ₓ=qₓ−F_{NH}/t_{NH}*tₓ

the result of which the spreader 108 may round up or down to the nearest integer, where qₓ is the current quantity remaining on the hedge order for leg X, F_{NH} is the quantity filled on the NoHedge order, t_{NH} is the trading ratio of the NoHedge order which is the same as the trading ratio of the filled working order from step 400, and tₓ is the trading ratio of leg X.

The ‘Auto Take Profit’ feature of the AST terminal 100 is activated by the user opening an ‘Auto Take Profit’ ticket from a spread template as summarised in step 142 of FIG. 1b and activating a first spread trade with this ticket as described below. When one of the working orders in the initial set of working orders of this first spread trade is filled the spreader component 108 immediately creates a second set of initial working orders for an ‘opposing’ spread trade to the first spread trade. This opposing spread trade is based on the same spread template as the first spread trade, but is assigned the opposite buy/sell type to the first spread trade. Additionally, if the opposing spread trade is given a buy/sell type of sell, then the spread order price of the opposing spread trade is adjusted to be higher than the spread order price of the first spread trade, according to a user-defined offset value, so that a profit will be made by completing the opposing spread trade. Similarly, if the opposing spread trade is given a buy/sell type of buy, then the spread order price of the opposing spread trade is adjusted to be lower than the spread order price of the first spread trade, according to a user-defined offset value. The user may enable a ‘Repeat’ setting 1208 on the ‘Auto Take Profit’ 100 ticket allowing the AST terminal 100 to submit a sequence of pairs of opposing spread trades in accordance with the above method.

The ‘Auto Take Profit’ feature of the AST terminal 100 thus allows the user to take advantage of volatility in the market for the contracts in the spread trade set of contracts of a spread trade. As the spreader component 108 immediately creates the opposing spread trade when one of the working orders in the initial set of working orders of the first spread trade completes, rapid changes in the market price of the contracts in the spread trade set of contracts of the spread that could allow the opposing spread trade to complete are caught by the AST terminal 100. The AST terminal 100 thus gains a significant processing advantage over existing spread trading terminals that would need to display the completion of the first spread trade and wait for the input from the user.

To use the ‘Auto Take Profit’ feature, the user creates an ‘Auto Take Profit’ ticket from a spread template as summarised in step 142 of FIG. 1b. FIG. 12a shows an exemplary screenshot of an ‘Auto Take Profit’ ticket, where the user can enter the buy/sell type of a first spread trade 1202 that will be based on the spread template from which the ticket was created, the price at which to buy/sell 1204 this first spread trade, and the quantity to buy/sell 1206 of the spread trade. If the user changes the buy/sell type of the first spread trade 1202 the buy/sell button 1210 that is used to activate the spread trade is changed accordingly as shown in FIG. 12c. The user can also enter a ‘Take Profit Amount’ 1200 that determines the change in the spread order price between a buy spread trade and a sell spread trade created for the ‘Auto Take Profit’ ticket, and a ‘Repeat’ setting 1208 that determines whether the a new ‘Auto Take Profit’ spread trade may be created after the completion of an ‘Auto Take Profit’ spread trade for this ticket.

Once the user has activated a first ‘Auto Take Profit’ spread trade by pressing on the buy/sell button 1210, the graphical user interface component 112 disables the buy/sell button 1210, enables a cancel button 1214 and indicates that an ‘Auto Take Profit’ spread trade is active on the ticket by displaying a box 1212 around the appropriate part of the ticket as shown in FIG. 12b. When the user activates the first spread trade the spreader component 108 gathers the information it requires to create this new spread trade, creates working orders for the initial set of working orders for this new spread trade at the electronic trading exchange system 122, and manages these working orders according to the steps illustrated in FIG. 2.

FIG. 5 illustrates additional steps performed by the spreader component 108 in response to a complete fill on one of the working legs in the initial set of working orders of an ‘Auto Take Profit’ spread trade (referred to herein as a hedged or opposing ‘Auto Take Profit’ spread trade). As the working orders of an ‘Auto Take Profit’ spread trade are filled the spreader 108 instructs the hedger 110 to execute hedge orders for the remaining legs to form the completing set of orders of the spread trade according to the steps illustrated in FIG. 3a (step 500). It is assumed that the hedger 110 will be able to fill the hedge orders forming the completing set of orders at a price consistent with the spread order price in order to complete the spread trade, thus once a working order in the initial set of working orders is completely filled an opposing ‘Auto Take Profit’ spread trade may be immediately created by the spreader 108 as described below. The hedger component 110 first checks whether the user has set the ‘Repeat’ setting 1208 on the ‘Auto Take Profit’ ticket for the completed ‘Auto Take Profit’ spread trade (step 502) and if not whether this is the first ‘Auto Take Profit’ order for this ‘Auto Take Profit’ ticket (step 504).

If either of the tests in steps 502 or 504 is satisfied, the spreader component 108 creates a new ‘Auto Take Profit’ spread trade (step 506) that opposes the ‘Auto Take Profit’ spread trade whose working order was filled in step 500 (i.e. the hedged ‘Auto Take Profit’ spread trade), by using the following information. The new ‘Auto Take Profit’ spread trade is assigned the same spread template as that of the hedged ‘Auto Take Profit’ spread, and the quantity multiplier of the new ‘Auto Take Profit’ spread trade is set the same as that of the hedged ‘Auto Take Profit’ spread trade. The buy/sell type of the new ‘Auto Take Profit’ spread trade is set to the opposite of the buy/sell type of the hedged ‘Auto Take Profit’ spread trade. Finally the spread price level of the new ‘Auto Take Profit’ spread trade is set as follows: if the buy/sell type of the new ‘Auto Take Profit’ spread trade is type buy, then the spread price level of the new ‘Auto Take Profit’ spread trade is calculated as the spread price level of the hedged ‘Auto Take Profit’ spread trade subtracted by the ‘Take Profit Amount’ 1200; if the buy/sell type of the new ‘Auto Take Profit’ spread trade is a type sell, then the spread price level of the new ‘Auto Take Profit’ spread trade is calculated as the spread price level of the hedged ‘Auto Take Profit’ spread trade added to the ‘Take Profit Amount’ 1200.

This information relating to the opposing spread trade is stored by the spreader 108 in spread trade progress data 109 for the spread trade, and is used to manage this new ‘Auto Take Profit’ spread trade as normal by the spreader component 108 and hedger component 110 according to the steps in FIGS. 2 and 3, respectively, however when one of the working orders in the initial set of working orders of the new ‘Auto Take Profit’ spread trade is completely filled, the spreader component 108 will once again perform the steps in FIG. 5 in order to provide the ‘Auto Take Profit’ features for the ‘Auto Take Profit’ ticket.

After performing steps 500 to 506 the spreader component 108 also instructs the graphical user interface component 112 to update the ‘Auto Take Profit’ ticket as follows (step 508). The buy/sell type 1202 displayed in the ticket window is changed to the opposite buy/sell type and the buy/sell button 1210 is also changed to the opposite buy/sell type (e.g. as shown by 1216 in FIG. 12c). If no further ‘Auto Take Profit’ spread trade was created by the spreader component 108 in step 506 (because the ‘Repeat’ option 1208 is not selected) the buy/sell button 1210 is re-enabled, the cancel button 1214 is disabled and the box 1212 indicating that an ‘Auto Take Profit’ spread trade is active is removed. Otherwise if a further ‘Auto Take Profit’ spread trade is created the buy/sell button 1210 remains disabled and the cancel button 1214 remains enabled.

The ‘Auto Reload’ feature of the AST terminal 100 is activated by the user opening an ‘Auto Reload’ ticket from a spread template as summarised in step 142 of FIG. 1b and activating a first spread trade with this ticket as described below. Once one of the working orders in the initial set of working orders of the first spread trade activated by the user has been completely filled, the spreader component 108 creates two initial sets of working orders for two further spread trades, the first spread trade of which is of the same buy/sell type as the first spread trade (this is called an ‘Auto Reload’ spread trade that ‘adds to the position’ according to a user-defined offset value defined in the spread template for the price of the spread trade), and the second of which is of the opposite buy/sell type to the first spread trade (this is called an ‘Auto Reload’ spread trade that ‘takes a profit’ according to a user-defined offset value defined in the spread template for the price of the spread trade). If the ‘Auto Reload’ spread trade that adds to the position is completed, the user will obtain more of the contracts obtained in the first spread trade at a more favourable price, according to the user-defined offset value defined in the spread template for the price of the “obtained” price of first spread trade, which is treated as having been obtained once one of the working orders in the initial set of working orders of the first spread trade activated by the user has been completely filled. If the ‘Auto Reload’ spread trade that takes a profit is completed the user will obtain a profit by ‘selling out’ the contracts obtained in the first spread trade at a more favourable price, according to the user-defined offset value defined in the spread template for the “selling out” price of the first spread trade, which is treated as having been obtained once one of the working orders in the initial set of working orders of the first spread trade activated by the user has been completely filled. The user may enable a ‘Repeat’ setting on the ‘Auto Reload’ ticket allowing the AST terminal 100 to repeat this behaviour every time a working order in the initial set of working orders belonging to an ‘Auto Reload’ spread trade is completely filled, so that an ‘Auto Reload’ spread trade to add to the position (provided that a user set limit has not been reached) and an ‘Auto Reload’ order to take a profit (provided that there is a position to take a profit from) are active at the electronic trading exchange system 122.

The ‘Auto Reload’ feature of the AST terminal 100 thus allows the user to take advantage of volatility in the market for the contracts forming the spread trade set of contracts of a spread trade. As the spreader component 108 creates the two further spread trades when a working order in the initial set working orders of an ‘Auto Reload’ spread trade is completely filled, immediate increases in the price of a spread trade can be taken advantage of in order to obtain a profit, and immediate decreases in the price of a spread trade can be taken advantage of in order to obtain more of the spread trade at a better price. As a result fluctuations in the price of a spread trade are taken advantage of by the AST terminal 100. The AST terminal 100 thus gains a significant processing advantage over existing spread trading terminals that would need to display the completion of a first spread trade on a graphical user interface and then wait for input from the user.

To use the ‘Auto Reload’ feature, the user creates an ‘Auto Reload’ ticket from a spread template as summarised in step 142 of FIG. 1b. FIG. 13a shows an exemplary screenshot of an ‘Auto Reload’ ticket, where the user can enter the buy/sell type 1302 of a first spread trade that will be based on the spread template from which the ticket was created, the spread order price at which to buy 1306 or sell 1310 this first spread trade (depending on the buy/sell type 1302 selected), and the quantity multiplier to use when buying 1308 or selling 1312 the spread trade. If the user changes the buy/sell type of the first spread trade 1302 the buy/sell button 1318 that is used to activate the first ‘Auto Reload’ spread trade is changed accordingly as shown in FIG. 13b. The user can also enter a ‘Take Profit Amount’ 1300 that determines the change in the spread order price when a new ‘Auto Reload’ spread trade that ‘takes a profit’ is created, an ‘Add To Position Amount’ 1304 that determines the change in the spread order price when a new ‘Auto Reload’ spread trade that ‘adds to the position’ is created. A ‘Repeat’ setting 1316 is provided that determines whether new ‘Auto Reload’ spread trades may be created for this ticket after the size of the ‘position’ obtained for this ‘Auto Reload’ ticket has returned to zero. Finally a ‘Maximum Position’ 1314 setting determines a limit to the size of the ‘position’ that the ‘Auto Reload’ feature can obtain for this ticket.

Once the user has activated a first ‘Auto Reload’ spread trade by pressing on the buy/sell button 1318, the graphical user interface component 112 disables the buy/sell button 1318, enables a cancel button 1320 and indicates that an ‘Auto Reload’ spread trade is active on the ticket by displaying a box 1322 around the appropriate part of the ticket, i.e. around the buy spread order price entry field 1306 and buy quantity multiplier entry field 1308 when an ‘Auto Reload’ spread trade with buy/sell type of type buy is active, and around the sell spread order price entry field 1310 and sell quantity multiplier entry field 1312 when an ‘Auto Reload’ spread trade with buy/sell type of type sell is active.

When the user activates the first ‘Auto Reload’ spread trade the spreader component 108 gathers the information it requires to create this new spread trade, creates working orders forming the initial set of working orders for this new spread trade at the electronic trading exchange system 122, and manages these working orders according to the steps illustrated in FIG. 2.

FIG. 6 illustrates additional steps performed by the spreader component 108 in response to a complete fill on one of the working orders in the initial set of working orders of an ‘Auto Reload’ spread trade (referred to herein as the hedged ‘Auto Reload’ spread trade). As the working orders in the initial set of working orders of an ‘Auto Reload’ spread trade are filled the spreader 108 instructs the hedger 110 to enter hedge orders for the remaining legs to form the completing set of orders of the spread trade according to the steps illustrated in FIG. 3a (step 602). It is assumed that the hedger 110 will be able to fill the hedge orders in the completing set of orders at a price consistent with the spread order price in order to complete the spread trade, thus once a working leg order in the initial set of working orders is completely filled further ‘Auto Reload’ spread trades may be immediately created by the spreader 108 as described below.

The spreader component 108 first checks whether the hedged ‘Auto Reload’ spread trade has ‘added to the position’ or whether it has ‘taken a profit’ (step 604). The first spread trade executed for an ‘Auto Reload’ ticket creates a position, i.e. contracts will be bought or sold on the market, and the user now has a position in the spread. Later ‘Auto Reload’ spread trades for the same ‘Auto Reload’ ticket having the same buy/sell type as the first spread trade will ‘add to the position’, i.e. the user will now have a larger position quantities in each of the contracts in the spread trade set of contracts. Later ‘Auto Reload’ spread trades for the same ‘Auto Reload’ ticket having the opposite buy/sell type to the first spread trade will be selling out contracts in the spread trade set of contracts that the user has a position in of as a result of previous spread trades that added to the position and so will ‘take a profit’ on the position that had been obtained by these previous spread trades.

If the spreader component 108 determines in step 604 that the hedged ‘Auto Reload’ spread trade added to the position, the value of the quantity multiplier of the hedged ‘Auto Reload’ spread trade is added to a ‘Filled units’ total, which is displayed in the ‘Auto Reload’ ticket window in the filled units field 1322 by the graphical user interface component 112 (step 606).

The spreader component 108 will then create working orders for a first initial set of working orders for a first new ‘Auto Reload’ spread trade to take a profit on the current position by using the following information relating to the new spread trade (step 608). The spread template of the new ‘Auto Reload’ spread trade will be the same spread template as that of the hedged ‘Auto Reload’ spread trade, the quantity multiplier of the new spread trade will be the same as that of the hedged ‘Auto Reload’ spread trade, and the new spread trade will have the opposite buy/sell type to the hedged ‘Auto Reload’ spread trade. The spread order price of the new spread trade will be the spread order price of the hedged ‘Auto Reload’ spread trade added to the ‘Take Profit Amount’ set by the user in the entry field 1300 on the ‘Auto Reload’ ticket if the buy/sell type of the new spread trade is of buy/sell type sell, and will be the spread order price of the hedged ‘Auto Reload’ spread trade subtracted by the ‘Take Profit Amount’ 1300 if the buy/sell type of the new spread trade is of buy/sell type buy. If an ‘Auto Reload’ spread trade taking profit on a previous position that has not yet had a working order in its initial set of working orders completely filled already exists for this ‘Auto Reload’ ticket, the spreader component 108 will cancel that ‘Auto Reload’ spread trade (step 610). This is done to prevent a large number of ‘Auto Reload’ orders that take a profit running simultaneously for a single ‘Auto Reload’ ticket, which would be difficult for a user to keep track of.

In alternative embodiments of the invention step 610 is not performed and new ‘Auto Reload’ spread trades taking profit on a new position are allowed to run concurrently with previous ‘Auto Reload’ spread trades taking profit on a previous position for the same ‘Auto Reload’ ticket.

The spreader component 108 then creates working orders for a second initial set of working orders for a second new ‘Auto Reload’ spread trade to add to the position, provided that the ‘Filled units’ total for the ‘Auto Reload’ ticket has not reached the ‘Maximum Position’ limit set by the user in field 1314 (step 612). The spreader component 108 uses the following information relating to the new spread trade if a new ‘Auto Reload’ spread trade to add to the position is to be created. The spread template of the new ‘Auto Reload’ spread trade will be the same spread template as that of the hedged ‘Auto Reload’ spread trade, the quantity multiplier of the new spread trade will be the same as that of the hedged spread trade, and the new spread trade will have the same buy/sell type as the hedged ‘Auto Reload’ spread trade. The spread order price of the new spread trade will be the spread order price of the hedged ‘Auto Reload’ spread trade subtracted by the ‘Add To Position Amount’ set by the user in the entry field 1304 on the ‘Auto Reload’ ticket if the new spread trade is of buy/sell type buy, and will be the spread order price of the hedged ‘Auto Reload’ spread trade added to the ‘Add To Position Amount’ 1304 if the new spread trade is of buy/sell type sell. If in step 612 the ‘Filled units’ total has reached the ‘Maximum Position’ limit then no new ‘Auto Reload’ spread trades to add to the position will be added at this point.

If it was determined in step 604 that the hedged ‘Auto Reload’ spread trade took a profit, i.e. the hedged ‘Auto Reload’ spread trade was of the opposite buy/sell type to the previous ‘Auto Reload’ spread trade created with the ‘Auto Reload’ ticket, the value of the quantity multiplier of the hedged ‘Auto Reload’ spread trade is subtracted from the ‘Filled units’ total by the spreader 108, which is displayed in the ‘Auto Reload’ ticket window in the filled units field 1326 by the graphical user interface component 112 (step 614).

The spreader component 108 then checks whether the ‘Repeat’ setting 1316 on the ‘Auto Reload’ ticket has been enabled (step 616), and if not will test if the hedged spread trade may be the last (step 618). The spreader component 108 will determine that the hedged spread trade may be the last by checking if the user no longer has a position for the ‘Auto Reload’ ticket (i.e. all contracts that were obtained by previous ‘Auto Reload’ spread trades that added to the position have now been sold out), which can be done by checking whether the ‘Filled units’ total is zero. If in step 618 the spreader component 108 determines that no further spread trades may be created for this ‘Auto Reload’ ticket (i.e. the ‘Filled units’ total is zero), it will cancel all working orders in the initial sets of working orders of any ‘Auto Reload’ spread trade that remains, at which point the spreader component 108 has finished managing this ‘Auto Reload’ ticket (step 626).

If in step 616 the spreader component 108 determined that the user had enabled the ‘Repeat’ setting 1316 for this ‘Auto Reload’ ticket or if in step 618 the spreader component 108 determined that more spread trades can be created for this ‘Auto Reload’ ticket, the spreader component 108 proceeds to step 620, where it creates working orders for a first initial set of working orders for a first new ‘Auto Reload’ spread trade to add to the current position by using the following information relating to the new spread trade. The spread template of the new ‘Auto Reload’ spread trade will be the same spread template as that of the hedged ‘Auto Reload’ spread trade, the quantity multiplier of the new spread trade will be the same as that of the hedged spread trade, and the new spread trade will have the opposite buy/sell type to the hedged ‘Auto Reload’ spread trade. The spread order price of the new spread trade will be the spread order price of the hedged ‘Auto Reload’ spread trade subtracted by the ‘Add To Position Amount’ set by the user in the entry field 1304 on the ‘Auto Reload’ ticket if the buy/sell type of the new spread trade is of type buy, and will be the spread order price of the hedged ‘Auto Reload’ spread trade added to the ‘Add To Position 1304 the buy/sell type of the new spread trade is of type sell.

If a previous ‘Auto Reload’ order adding to a position for this ticket exists that has not yet had a working order in its initial set of working orders completely filled, the spreader component 108 cancels that ‘Auto Reload’ spread trade (step 622). This is done to prevent a large number of ‘Auto Reload’ orders that add to the position running simultaneously for a single ‘Auto Reload’ ticket, which would be difficult for a user to keep track of.

In alternative embodiments of the invention step 622 is not performed and new ‘Auto Reload’ spread trades adding to a position are allowed to run concurrently with previous ‘Auto Reload’ spread trades adding to a position for the same ‘Auto Reload’ ticket.

The spreader component 108 then creates working orders for a second initial set of working orders for a second new spread trade to take profit on the position, provided that the ‘Filled units’ total is not zero (in which case the user does not currently have a position for this spread trade, hence there is no position to take profit on) (step 624). The spreader component 108 uses the following information relating to the new spread trade if a new ‘Auto Reload’ spread trade to take a profit is to be created. The spread template of the new ‘Auto Reload’ spread trade will be the same spread template as that of the hedged ‘Auto Reload’ spread trade, the quantity multiplier of the new spread trade will be the same as that of the hedged spread trade, and the new spread trade will have the same buy/sell type as the hedged ‘Auto Reload’ spread trade. The spread order price of the new spread trade will be the spread order price of the hedged ‘Auto Reload’ spread trade added to the ‘Take Profit Amount’ set by the user in the entry field 1300 on the ‘Auto Reload’ ticket if the buy/sell type of the new spread trade is of type sell, and will be the spread order price of the hedged ‘Auto Reload’ spread trade subtracted by the ‘Take Profit Amount’ set by the user in the entry field 1300 on the ‘Auto Reload’ ticket if the buy/sell type of the new spread trade is of type buy.

Information relating to new ‘Auto Reload’ spread trades created in steps 608, 612, 620 and 624 is stored by the spreader 108 in spread trade progress data 109 for the spread trade and is used to manage these as normal by the spreader component 108 and hedger component 110 according to the steps in FIGS. 2 and 3, respectively, however when one of the working orders of the initial sets of working orders of one of these new ‘Auto Reload’ spread trades is completely filled, the spreader component 108 will once again perform the steps in FIG. 6 in order to provide the ‘Auto Reload’ features enabled by the user.

When one of the working orders of the initial set of working orders of an ‘Auto Reload’ order is completely filled the spreader component 108 also instructs the graphical user interface component 112 to update the ‘Auto Reload’ ticket as follows (step 628). If no further ‘Auto Reload’ spread trades are created by the spreader component 108 in steps 608, 612, 620 and 624 (because the ‘Repeat’ setting 1316 is not selected and because the last ‘Auto Reload’ spread trade has completed) the buy/sell button 1318 is re-enabled, the cancel button 1320 is disabled and the boxes 1322 and 1324 indicating that ‘Auto Reload’ spread trade of buy/sell types buy and sell are active, respectively, are removed. Otherwise if further ‘Auto Reload’ spread trades are created the buy/sell button 1318 remains disabled, the cancel button 1320 remains enabled and the boxes 1322 and 1324 indicating that ‘Auto Reload’ spread trade of buy/sell types buy and sell are active are displayed, according to whether these ‘Auto Reload’ spread trades have been created or not.

The above embodiments are to be understood as illustrative examples of the invention. Further embodiments of the invention are envisaged as follows.

Embodiments of the invention are envisaged where a working order in the initial set of working orders of an ‘Auto Take Profit’ spread trade does not have to be completely filled in order for an opposing ‘Auto Take Profit’ spread trade to be created according to the steps shown in FIG. 5. In these embodiments of the invention the quantity multiplier of the opposing ‘Auto Take Profit’ spread trade that is created in step 506 is determined by the spreader 108 according to the amount filled on the hedged ‘Auto Take Profit’ spread trade in step 500 using:

Qₒ=Fₐ/tₐ

where Qₒ is the quantity multiplier of the opposing ‘Auto Take Profit’ spread trade, Fₐ and tₐ are the quantity filled and the trading ratio of the partially filled working order of the hedged ‘Auto Take Profit’ spread trade, respectively.

Embodiments of the invention are envisaged where a working order in the initial set of working orders of an ‘Auto Reload’ spread trade does not have to be completely filled in order for further ‘Auto Reload’ spread trade to be created according to the steps shown in FIG. 6. In these embodiments of the invention the quantity multiplier of the further ‘Auto Reload’ spread trades that are created in steps 608, 612, 620 and 624 are determined by the spreader 108 according to the amount filled on the hedged ‘Auto Reload’ spread trade in step 600 using:

Q_{f}=Fₐ/tₐ

where Q_{f} is the quantity multiplier of a further ‘Auto Reload’ spread trade created in either step 608, 612, 620 or 624, Fₐ and tₐ are the quantity filled and the trading ratio of the partially filled working leg of the hedged ‘Auto Reload’ spread trade, respectively.

Embodiments of the invention are envisaged where the Tick No Hedge feature can be used in combination with either the Auto Take Profit feature or the Auto Reload feature. In these embodiments of the invention the steps shown in FIG. 4 are performed by the spreader component 108 when a first spread trade that is either an ‘Auto Take Profit’ spread trade or an ‘Auto Reload’ spread trade that has Tick No Hedge enabled on at least one of its working legs and has a working order belonging to its initial set of working orders filled (i.e. step 401 onwards). Additionally, the spreader 108 will also perform the steps in either FIG. 5 or FIG. 6 depending on whether the first spread trade is an ‘Auto Take Profit’ or ‘Auto Reload’ spread trade, in order to create an additional spread trade in step 506 if the first spread trade is an ‘Auto Take Profit’ spread trade, or additional spread trades in steps 608 and 612 or 620 and 624 if the first spread trade is an ‘Auto Reload’ spread trade.

Later, if the spreader 108 cancels the hedge orders in the completing set of orders of the first spread trade in step 422 according to the Tick No Hedge feature, that first spread trade is cancelled. Additionally, the additional spread trade created in step 506 or additional spread trades that were created in any of steps 608 and 612 or 620 and 624 may be cancelled by the spreader 108 by cancelling the working orders of the initial sets of working orders of those spread trades. This may lead to the cancellation of an activated ‘Auto Take Profit’ or ‘Auto Reload’ ticket. If the user has enabled the ‘RepeatNoHedge’ parameter for the working leg with Tick No Hedge enabled that is filled in step 401 for the first spread trade, then instead of the first spread trade being cancelled in step 422 the spreader component 108 will ‘restart’ the first spread trade by creating new working orders forming a new initial set of working orders for the first spread trade that is managed by the spreader component 108, allowing the ‘Auto Take Profit’ or ‘Auto Reload’ ticket to continue as normal.

Conversely, if an order belonging to one of working orders of the initial set of working orders of the additional spread trade (or any of the additional spread trades if the first spread trade is an ‘Auto Reload’ spread trade) is filled, then the spreader 108 may cancel the Tick No Hedge order for the first spread trade and continue managing the fill on the working order for the additional spread trade as normal according to FIG. 2 and either FIG. 5 or FIG. 6, depending on whether the first spread trade is an ‘Auto Take Profit’ or ‘Auto Reload’ spread trade.

Alternative embodiments of the invention are envisaged wherein the hedger 110 may not calculate the price to use for a new hedge order in step 304 when executing a new hedge order according to the steps in FIG. 3, but may instead use a ‘market order’ to create an order for the hedge order in step 308. A ‘market order’ is an order that does not contain a price value. When the electronic exchange trading system 122 receives a market order it will match that order at the best price available for that order's contract and buy/sell type, hence the hedger 110 may avoid receiving price data updates from the electronic trading exchange system 122 in step 302 and calculating the bid/offer price of a hedge order in step 304 in order to gain a processing advantage and execute a hedge order immediately, if necessary.

Alternative embodiments of the invention are envisaged wherein the user may not mark any of the legs of a spread template as working legs in order to create a spread template for a ‘No Working Legs’ order. When a spread trade based on this spread template is executed the spreader 108 may not create an initial set of working orders, and instead orders forming a completing set of orders for all the legs of the spread trade are executed by the hedger 110. In this case in step 204 the spreader 108 immediately instructs the hedger 110 to execute a hedge order for every leg of the spread trade (i.e. one order for every contract in the spread trade set of contracts) using the buy/sell types and quantities determined in step 200. The spreader 108 may not create an initial set of working orders and may not proceed with the remaining steps following step 204 in FIG. 2, but instead may finish managing this new spread trade at this point. The hedge orders requested by the spreader 108 and executed by the hedger 110 form the completing set of orders for the spread trade, and are managed by the hedger 110 as normal according to the steps shown in FIG. 3. This embodiment may used in combination with any of the features described above.

Alternative embodiments of the invention are envisaged wherein, during management of a new spread trade according to the steps in FIG. 2, the spreader 108 may not create working orders forming an initial set of working orders for the spread trade if in step 204 it detects that the calculated buy/sell prices that would be used for these working orders would be immediately satisfied under current market conditions known from recent trade data and current market data, in order to create a ‘Monitor Only’ order. In this case in step 204 the spreader 108 immediately instructs the hedger 110 to execute a hedge order for every leg of the spread trade (i.e. one order for every contract in the spread trade set of contracts) using the buy/sell types and quantities determined in step 200. The spreader 108 may not create an initial set of working orders and may not proceed with the remaining steps following step 204 in FIG. 2, but instead may finish managing this new spread trade at this point. The hedge orders requested by the spreader 108 and executed by the hedger 110 form the completing set of orders for the spread trade, and are managed by the hedger 110 as normal according to the steps shown in FIG. 3. This embodiment may used in combination with any of the features described above.

Alternative embodiments of the invention are envisaged wherein the exchange interface 106, spreader 108 and hedger 110 are not located within same terminal or general purpose computer as the graphical user interface 112. In this case the graphical user interface 112 may be located at a remote terminal at the location of a user that may also comprise the video output component 116 and video display 118 to display windows, tickets, etc. generated by the graphical user interface 112 to the user. The remote terminal also comprises of a network interface with which to communicate with the exchange interface 106, spreader 108 and hedger 110 that are located at an Automated Spread Trading (AST) server. The AST server in this embodiment includes a microprocessor 102 that processes instructions in the form of electronic signals stored in a random access memory (RAM) that have been loaded from a computer-readable medium such as a hard disk. These instructions are in the form of computer software, in the form of one or more programs that implement the exchange interface 106, the spreader component 108, and the hedger component 110. The AST server comprises RAM in which spread trade progress data 109 is stored as well as a network interface that allows the exchange interface 106 to communicate with the electronic trading exchange system 122, and allows the exchange interface 106, spreader 108 and hedger 110 to communicate with the graphical user interface 112 at the remote terminal. The AST server may be placed within a communications network such as a private communications network that is closely coupled to the electronic trading exchange system 122 or a plurality of such electronic trading exchange systems, in order for the AST server to be able to transmit and receive information in the form of current market data, recent trade data and/or messages from the electronic trading exchange system 122 with lower latency than would be possible from the remote terminal.

Alternative embodiments of the invention are envisaged wherein the spreader component 108 and hedger component 110 are not located within the same terminal or general purpose computer. In this case spread trade progress data 109 may be held in RAM at the terminal or general purpose computer where the spreader 108 is located, or where the hedger 110 is located, or may be held in both of these terminals or general purpose computers, or may be held in a separate terminal or general purpose computer. The spreader 108 and hedger 109 may co-operate in order to access and maintain spread trade progress data 109, and/or they may transmit data between them in order to access and maintain this data. Additionally the graphical user interface component 112 may be located in the same terminal as either the spreader 108 or hedger 110 or may be located in a separate terminal or general purpose computer. Additionally the exchange interface 106 may be located in the same terminal as the spreader 108 or hedger 110 or in a separate terminal or general purpose computer or there may be a separate exchange interface 106 for both the spreader 108 and hedger that may be located in the same terminal or general purpose computer as the spreader 108 or hedger 110 respectively. In each of these cases the separate terminals or general purpose computers each comprise a network interface with which to communicate with the components located at separate terminals via a communications network or a plurality of such communications networks.

Alternative embodiments of the invention are envisaged wherein the spreader component 108 and/or hedger component 110 may be partially or entirely implemented in specialised hardware circuitry such as for example an Application-Specific Integrated Circuit (ASIC) or a Field-Programmable Gate Array (FPGA) located within the AST terminal 100, rather than entirely processed by the microprocessor 102. These embodiments allow the AST terminal 100 to quickly process information received in the form of current market data, recent trade data and/or messages from the electronic trading exchange system 122 and then respond to this information as soon as possible, in order to gain a processing advantage over other terminals 128.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A computer-implemented method for generating and transmitting, via a data communications network, messages related to a spread trade, said method comprising:
receiving from a user a selection of a spread trade indicative of a set of trading contracts defined in relation to the spread trade;
transmitting to at least one electronic trading exchange a first set of one or more messages, including one or more order messages relating to said user selection such that an initial set of one or more working orders, each corresponding to one of the trading contracts defined in relation to the selected spread trade are rendered operative in the at least one electronic trading exchange;
receiving from the at least one electronic trading exchange a first fill confirmation message confirming the at least partial completion of a first working order in said initial set of working orders; and
in response to receiving said first fill confirmation message, transmitting to at least one of the at least one electronic trading exchanges both:
a) a second set of one or more messages, including one or more order messages and/or order modification messages, relating to said user selection such that a completing set of one or more working orders, each corresponding to one or more of the trading contracts defined in relation to the selected spread trade, are rendered operative in the at least one of the at least one electronic trading exchanges, the completing set of working orders relating to one or more trading contracts including one or more trading contracts other than the trading contract in relation to which said first fill confirmation message has been received and the completing set of working orders being completed subsequent to said second set of messages being sent, when one or more further fill confirmation messages are received; and
b) a third set of one or more messages, including one or more order messages relating to said user selection such that an additional set of one or more working orders, each corresponding to one or more of the trading contracts defined in relation to the selected spread trade, are rendered operative in the at least one of the at least one electronic trading exchanges, the additional set of working orders relating to one or more trading contracts including the trading contract in relation to which said first fill confirmation message has been received,
wherein said third set of messages are transmitted before said completing set of working orders is completed.

2. A method according to claim 1, wherein said third set of messages comprises one order message only, said one order message relating to the trading contract in relation to which said first fill confirmation message has been received.

3. A method according to claim 1, wherein said third set of messages comprises a plurality of order messages, one of said plurality of order messages relating to the trading contract in relation to which said first fill confirmation message has been received and at least one other of said plurality of order messages relating to one or more other trading contracts from the trading contracts defined in relation to the selected spread trade.

4. A method according to claim 1, wherein order messages in said first and third sets of messages comprise a buy/sell type, and the buy/sell type of an order message in said third set of order messages is opposite to the buy/sell type of the order message in a corresponding one of said first set of order messages that relates to the same trading contract.

5. A method according to claim 1, wherein order messages in said first and third sets of messages comprise a buy/sell type, and the buy/sell type of an order message in said third set of order messages is the same as the buy/sell type of the order message in a corresponding one of said first set of order messages that relates to the same trading contract.

6. A method according to claim 1, wherein one or more order messages in said third set of messages indicate a price value which is calculated at least in part in accordance with a user-defined offset value.

7. A method according to claim 1, wherein order messages in said first and third sets of messages each comprise a quantity value, wherein said first fill confirmation message comprises a filled order quantity value, and the quantity values of the one or more order messages in the third set of messages are calculated according to the filled order quantity value contained in the first fill confirmation message.

8. A method according to claim 1, wherein order messages in said first set of messages comprise a price value, and comprising:
receiving from the electronic trading exchange current market data including data indicative of the price values of orders queued at the electronic trading exchange relating to at least some of the set of trading contracts defined in relation to the spread trade; and
selecting the price value of an order message in said first set of messages according to said current market data.

9. A method according to claim 1, comprising:
receiving from the electronic trading exchange a second fill confirmation message, said second fill confirmation message relating to a working order in said additional set of working orders and relating to the trading contract in relation to which said first fill confirmation message has been received, and
in response to receiving said second fill confirmation message, cancelling or modifying said completing set of working orders.

10. A method according to claim 9, wherein said second fill confirmation message comprises a filled order quantity value, the method comprising, when said filled order quantity value is less than a quantity value of a corresponding working order in said additional set of working orders:
in response to receiving said second fill confirmation message, transmitting to the electronic trading exchange one or more order modification data messages relating to said completing set of working orders, wherein said one or more order modification data messages comprise a modified quantity value, said modified quantity value depending on the filled quantity value contained in the second fill confirmation message.

11. A method according to claim 1, comprising:
receiving from the electronic trading exchange one or more further fill confirmation messages, one or more further fill confirmation messages relating to all working orders in said completing set of working orders; and
in response to receiving said one or more further fill confirmation messages, cancelling or modifying said additional set of working orders.

12. A method according to claim 1, wherein said additional set of working orders comprises working orders corresponding to each of said initial set of working orders.

13. A method according to claim 12, wherein working orders comprise a buy/sell type, and the buy/sell type of the working orders corresponding to each of said additional set of working orders is opposite to the buy/sell type of each of said initial set of working orders.

14. A method according to claim 12, wherein working orders comprise a buy/sell type, and the buy/sell type of the working orders corresponding to each of said additional set of working orders is the same as the buy/sell type of each of said initial set of working orders.

15. A method according to claim 1, wherein said method is conducted by a computer terminal.

16. A non-transitory computer-readable storage medium having computer readable instructions stored thereon, the computer readable instructions being executable by a computerized device to cause the computerized device to conduct a computer-implemented method for generating and transmitting, via a data communications network, messages related to a spread trade, said method comprising:
receiving from a user a selection of a spread trade indicative of a set of trading contracts defined in relation to the spread trade;
transmitting to at least one electronic trading exchange a first set of one or more messages, including one or more order messages relating to said user selection such that an initial set of one or more working orders, each corresponding to one of the trading contracts defined in relation to the selected spread trade are rendered operative in the at least one electronic trading exchange;
receiving from the at least one electronic trading exchange a first fill confirmation message confirming the at least partial completion of a first working order in said initial set of working orders; and
in response to receiving said first fill confirmation message, transmitting to at least one of the at least one electronic trading exchanges both:
a) a second set of one or more messages, including one or more order messages and/or order modification messages, relating to said user selection such that a completing set of one or more working orders, each corresponding to one or more of the trading contracts defined in relation to the selected spread trade, are rendered operative in the at least one of the at least one electronic trading exchanges, the completing set of working orders relating to one or more trading contracts including one or more trading contracts other than the trading contract in relation to which said first fill confirmation message has been received and the completing set of working orders being completed subsequent to said second set of messages being sent, when one or more further fill confirmation messages are received; and
b) a third set of one or more messages, including one or more order messages relating to said user selection such that an additional set of one or more working orders, each corresponding to one or more of the trading contracts defined in relation to the selected spread trade, are rendered operative in the at least one of the at least one electronic trading exchanges, the additional set of working orders relating to one or more trading contracts including the trading contract in relation to which said first fill confirmation message has been received,
wherein said third set of messages are transmitted before said completing set of working orders is completed.

17. A computer implemented method for transmitting to an electronic trading exchange, via a data communications network, one or more messages relating to a set of orders related to a spread trade, said spread trade relating to a selection of spread trade contracts, to render operative one or more working orders relating to one or more contracts in said selection of spread trade contracts, said method comprising:
receiving fill confirmation data from the electronic trading exchange confirming the at least partial completion of a first working order, said first working order relating to a first spread trade;
in response to receiving said fill confirmation data from the electronic trading exchange, transmitting to the electronic trading exchange one or more messages relating to a set of one or more completing orders relating to the first spread trade such that there is an order in said set of completing orders for one or more contracts in said selection of spread trade contracts other than a contract to which the first working order relates; and
transmitting to the electronic trading exchange one or more messages relating to an opposing additional order, wherein said opposing additional order relates to the same contract as the first order.

18. A computer-implemented method for transmitting to an electronic trading exchange, via a data communications network, one or more messages relating to a set of order messages related to a spread trade, said spread trade relating to a selection of spread trade contracts, to render operative one or more working orders relating to one or more contracts in said selection of spread trade contracts, said method comprising:
receiving fill confirmation data from the electronic trading exchange confirming the at least partial completion of a first working order, said first working order relating to a first spread trade;
in response to receiving said fill confirmation data from the electronic trading exchange, transmitting to the electronic trading exchange one or more messages relating to a set of one or more completing orders relating to the first spread trade such that there is an order in said set of completing orders for one or more contracts in said selection of spread trade contracts other than a contract to which the first working order relates; and
transmitting to the electronic trading exchange one or more messages relating to a set of one or more opposing additional orders relating to an spread trade such that for every working order in said first set of one or more working orders there is an opposing working order relating to the same contract as the working order in said set of opposing additional working orders.

19. A computer-implemented method for transmitting to an electronic trading exchange, via a data communications network, one or more messages relating to a set of order messages related to a spread trade, said spread trade relating to a selection of spread trade contracts, to render operative one or more working orders relating to one or more contracts in said selection of spread trade contracts, said method comprising:
receiving fill confirmation data from the electronic trading exchange confirming the at least partial completion of a first working order, said first working order relating to a first spread trade,
in response to receiving said fill confirmation data from the electronic trading exchange, transmitting to the electronic trading exchange one or more messages relating to a set of one or more completing orders relating to the first spread trade for one or more contracts in said selection of spread trade contracts other than a contract to which the first working order relates,
transmitting to the electronic trading exchange one or more messages relating to a first set of one or more additional orders relating to a spread trade adding to the position such that for one or more working orders in said first set of one or more additional orders there is an adding working order relating to the same contract as the completed first working order; and
transmitting to the electronic trading exchange one or more messages relating to a second set of one or more additional orders relating to an opposing spread trade such that for one or more working orders in said second set of one or more additional orders there is an opposing working order relating to the same contract as the completed first working order.
